(19) United States
(12) Patent Application Publication
(10) Pub. No.: US 2024/0107456 A1
(43) Pub. Date: Mar. 28, 2024

(54) LOW POWER WAKE UP RADIO IN SIDELINK COMMUNICATIONS

(71) Applicant: QUALCOMM Incorporated, San Diego, CA (US)

(72) Inventors: Ahmed Elshafie, San Diego, CA (US); Huilin Xu, Temecula, CA (US); Wei Yang, San Diego, CA (US); Seyedkianoush Hosseini, San Diego, CA (US); Wanshi Chen, San Diego, CA (US); Linhai He, San Diego, CA (US); Yuchul Kim, San Diego, CA (US)

(21) Appl. No.: 17/955,339

(22) Filed: Sep. 28, 2022

(51) Int. Cl. H04W 52/02; H04W 72/12

(52) U.S. Cl. CPC H04W 52/0235; H04W 52/0219; H04W 72/1278

(57) ABSTRACT

Methods, systems, and devices for wireless communications are described. Techniques described herein relate to a network entity indicating a configuration for a user equipment (UE) for wake up radio signaling when the main radio of the UE is in a sleep mode. The UE may monitor for and receive, using the wake up radio, a wake up signal, a low power reference signal, or a low power synchronization signal from a second UE in accordance with the configuration. If the UE receives a wake up signal from the second UE, the UE may establish communications with the second UE or with the network entity based on the wake up signal.

### FIELD OF TECHNOLOGY

The following relates to wireless communications, including low power wake up radio in sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support low power wake up radio in sidelink communications. For example, the described techniques provide for a configuration for wake up radio signaling when main radio of a user equipment (UE) is in a sleep mode. The UE may monitor for and receive, using a wake up radio, a wake up signal from a second UE in accordance with the configuration. If the UE receives a wake up signal from the second UE, the UE may establish communications with the second UE or with the network entity based on the wake up signal.

A method for wireless communications at a first user equipment (UE) is described. The method may include receiving, from a network entity via a first radio of the first UE, control signaling indicating a configuration associated with a set of sidelink communication resources for receiving signaling via a wake up radio of the first UE while the first radio is in a sleep mode and receiving, from a second UE via the wake up radio while the first radio is in the sleep mode, a signal via the set of sidelink communication resources in accordance with the configuration.

An apparatus for wireless communications at a first UE is described. The apparatus may include a processor, memory coupled with the processor, and instructions stored in the memory. The instructions may be executable by the processor to cause the apparatus to receive, from a network entity via a first radio of the first UE, control signaling indicating a configuration associated with a set of sidelink communication resources for receiving signaling via a wake up radio of the first UE while the first radio is in a sleep mode and receive, from a second UE via the wake up radio while the first radio is in the sleep mode, a signal via the set of sidelink communication resources in accordance with the configuration.

Another apparatus for wireless communications at a first UE is described. The apparatus may include means for receiving, from a network entity via a first radio of the first UE, control signaling indicating a configuration associated with a set of sidelink communication resources for receiving signaling via a wake up radio of the first UE while the first radio is in a sleep mode and means for receiving, from a second UE via the wake up radio while the first radio is in the sleep mode, a signal via the set of sidelink communication resources in accordance with the configuration.

A non-transitory computer-readable medium storing code for wireless communications at a first UE is described. The code may include instructions executable by a processor to receive, from a network entity via a first radio of the first UE, control signaling indicating a configuration associated with a set of sidelink communication resources for receiving signaling via a wake up radio of the first UE while the first radio is in a sleep mode and receive, from a second UE via the wake up radio while the first radio is in the sleep mode, a signal via the set of sidelink communication resources in accordance with the configuration.

Some examples of the method, apparatuses, and non-transitory computer-readable medium described herein may further include operations, features, means, or instructions for communicating with one of the network entity or the second UE via the first radio based on receiving the signal via the wake up radio, where the signal includes a wake up signal.

In some examples of the method, apparatuses, and non-transitory computer-readable medium described herein, receiving the control signaling may include operations, features, means, or instructions for receiving an indication of a first subset of the set of sidelink communication resources associated with wake up signals for communications with the network entity and a second subset of the set of sidelink communication resources associated with wake up signals for communications with other UEs, and where communicating with the one of the network entity or the second UE may be based on the signal being received via the first subset or the second subset.

In some examples of the method, apparatuses, and non-transitory computer-readable medium described herein, receiving the control signaling may include operations, features, means, or instructions for receiving an indication of one or more of a first discontinuous reception configuration associated with the first subset and a second discontinuous reception configuration associated with the second subset.

In some examples of the method, apparatuses, and non-transitory computer-readable medium described herein, a first discontinuous reception configuration associated with the first subset may be associated with a first radio resource control state between the first UE and the network entity, a second discontinuous reception configuration associated with the first subset may be associated with a second radio resource control state between the first UE and the network entity, a third discontinuous reception configuration associated with the first subset may be associated with a third radio resource control state between the first UE and the network entity, a fourth discontinuous reception configuration associated with the second subset may be associated with a fourth radio resource control state between the first UE and the second UE, a fifth discontinuous reception configuration associated with the second subset may be associated with a fifth radio resource control state between the first UE and the second UE, and a sixth discontinuous reception configuration associated with the second subset may be associated with a sixth radio resource control state between the first UE and the second UE.

In some examples of the method, apparatuses, and non-transitory computer-readable medium described herein, receiving the control signaling may include operations, features, means, or instructions for receiving an indication of the configuration per resource pool, where the set of sidelink communication resources includes a resource pool of a set of multiple resource pools associated with a bandwidth part associated with sidelink communications for the first UE.

Some examples of the method, apparatuses, and non-transitory computer-readable medium described herein may further include operations, features, means, or instructions for transmitting, to the network entity, an indication of a UE type of the first UE, where the configuration may be based on the UE type.

In some examples of the method, apparatuses, and non-transitory computer-readable medium described herein, the set of sidelink communication resources includes a resource pool and the configuration includes a set of reference signal monitoring occasions for the resource pool, a set of synchronization signal monitoring occasions for the resource pool, a set of wake up signal monitoring occasions, or a combination thereof.

Some examples of the method, apparatuses, and non-transitory computer-readable medium described herein may further include operations, features, means, or instructions for receiving, from a third UE via the wake up radio while the first radio may be in the sleep mode, a second signal via a default resource pool in accordance with a default configuration.

Some examples of the method, apparatuses, and non-transitory computer-readable medium described herein may further include operations, features, means, or instructions for transmitting an indication of a quantity of resource pools the UE may be capable of supporting via the wake up radio, where the configuration may be based on the indication of the quantity of resource pools the UE may be capable of supporting via the wake up radio.

In some examples of the method, apparatuses, and non-transitory computer-readable medium described herein, receiving the control signaling may include operations, features, means, or instructions for receiving an indication of whether a reference signal, a synchronization signal, or a combination thereof may be enabled for a resource pool corresponding to the set of sidelink communication resources.

In some examples of the method, apparatuses, and non-transitory computer-readable medium described herein, receiving the control signaling may include operations, features, means, or instructions for receiving an indication that a synchronization signal may be enabled for a resource pool corresponding to the set of sidelink communication resources, where the synchronization signal may be located outside of the resource pool.

In some examples of the method, apparatuses, and non-transitory computer-readable medium described herein, receiving the control signaling may include operations, features, means, or instructions for receiving an indication of a set of multiple resource pools for sidelink communications, where the set of sidelink communication resources include a resource pool of the set of multiple resource pools, where the first UE deactivates monitoring of each resource pool of the set of multiple resource pools except for the resource pool while the first radio may be in the sleep mode.

In some examples of the method, apparatuses, and non-transitory computer-readable medium described herein, receiving the control signaling may include operations, features, means, or instructions for receiving an indication that the configuration may be associated with the second UE.

In some examples of the method, apparatuses, and non-transitory computer-readable medium described herein, receiving the control signaling may include operations, features, means, or instructions for receiving an indication that the configuration may be associated with a first sub-resource pool of a resource pool for sidelink communications, where the set of sidelink communication resources includes the first sub-resource pool, and where a guard band separates the first sub-resource pool from a second sub-resource pool of the resource pool.

Some examples of the method, apparatuses, and non-transitory computer-readable medium described herein may further include operations, features, means, or instructions for receiving, with the control signaling, an indication of a set of multiple configurations associated with the set of sidelink communication resources, the set of multiple configurations including the configuration and receiving, from the second UE, second control signaling indicating the configuration from the set of multiple configurations.

A method for wireless communications at a second UE is described. The method may include receiving, from a network entity, control signaling indicating a configuration associated with a set of sidelink communication resources for transmitting signaling to a first UE while a first radio of the first UE is in a sleep mode and transmitting, to the first UE, a signal via the set of sidelink communication resources in accordance with the configuration.

An apparatus for wireless communications at a second UE is described. The apparatus may include a processor, memory coupled with the processor, and instructions stored in the memory. The instructions may be executable by the processor to cause the apparatus to receive, from a network entity, control signaling indicating a configuration associated with a set of sidelink communication resources for transmitting signaling to a first UE while a first radio of the first UE is in a sleep mode and transmit, to the first UE, a signal via the set of sidelink communication resources in accordance with the configuration.

Another apparatus for wireless communications at a second UE is described. The apparatus may include means for receiving, from a network entity, control signaling indicating a configuration associated with a set of sidelink communication resources for transmitting signaling to a first UE while a first radio of the first UE is in a sleep mode and means for transmitting, to the first UE, a signal via the set of sidelink communication resources in accordance with the configuration.

A non-transitory computer-readable medium storing code for wireless communications at a second UE is described. The code may include instructions executable by a processor to receive, from a network entity, control signaling indicating a configuration associated with a set of sidelink communication resources for transmitting signaling to a first UE while a first radio of the first UE is in a sleep mode and transmit, to the first UE, a signal via the set of sidelink communication resources in accordance with the configuration.

Some examples of the method, apparatuses, and non-transitory computer-readable medium described herein may further include operations, features, means, or instructions for communicating with the first UE based on transmitting the signal, where the signal includes a wake up signal.

In some examples of the method, apparatuses, and non-transitory computer-readable medium described herein, receiving the control signaling may include operations, features, means, or instructions for receiving an indication of a first subset of the set of sidelink communication resources associated with wake up signals for communications with the network entity and a second subset of the set of sidelink communication resources associated with wake up signals for communications with other UEs, and where communicating with the first UE may be based on the signal being transmitted via the second subset.

In some examples of the method, apparatuses, and non-transitory computer-readable medium described herein, receiving the control signaling may include operations, features, means, or instructions for receiving an indication of one or more of a first discontinuous reception configuration associated with the first subset and a second discontinuous reception configuration associated with the second subset.

In some examples of the method, apparatuses, and non-transitory computer-readable medium described herein, receiving the control signaling may include operations, features, means, or instructions for receiving an indication of the configuration per resource pool, where the set of sidelink communication resources includes a resource pool of a set of multiple resource pools associated with a bandwidth part associated with sidelink communications for the first UE.

In some examples of the method, apparatuses, and non-transitory computer-readable medium described herein, the set of sidelink communication resources includes a resource pool and the configuration includes a set of reference signal monitoring occasions for the resource pool, a set of synchronization signal monitoring occasions for the resource pool, a set of wake up signal monitoring occasions, or a combination thereof.

In some examples of the method, apparatuses, and non-transitory computer-readable medium described herein, receiving the control signaling may include operations, features, means, or instructions for receiving an indication of whether a reference signal, a synchronization signal, or a combination thereof may be enabled for a resource pool corresponding to the set of sidelink communication resources.

In some examples of the method, apparatuses, and non-transitory computer-readable medium described herein, receiving the control signaling may include operations, features, means, or instructions for receiving an indication that a synchronization signal may be enabled for a resource pool corresponding to the set of sidelink communication resources, where the synchronization signal may be located outside of the resource pool.

In some examples of the method, apparatuses, and non-transitory computer-readable medium described herein, receiving the control signaling may include operations, features, means, or instructions for receiving an indication of a set of multiple resource pools for sidelink communications, where the set of sidelink communication resources include a resource pool of the set of multiple resource pools.

In some examples of the method, apparatuses, and non-transitory computer-readable medium described herein, receiving the control signaling may include operations, features, means, or instructions for receiving an indication that the configuration may be associated with the first UE.

In some examples of the method, apparatuses, and non-transitory computer-readable medium described herein, receiving the control signaling may include operations, features, means, or instructions for receiving an indication that the configuration may be associated with a first sub-resource pool of a resource pool for sidelink communications, where the set of sidelink communication resources includes the first sub-resource pool, and where a guard band separates the first sub-resource pool from a second sub-resource pool of the resource pool.

Some examples of the method, apparatuses, and non-transitory computer-readable medium described herein may further include operations, features, means, or instructions for receiving, with the control signaling, an indication of a set of multiple configurations associated with the set of sidelink communication resources, the set of multiple configurations including the configuration and transmitting, to the first UE, second control signaling indicating the configuration from the set of multiple configurations.

A method for wireless communications at a network entity is described. The method may include receiving, from a first UE, an indication of a UE type of the first UE and transmitting, to the first UE, control signaling indicating a configuration associated with a set of sidelink communication resources for receiving signaling from a second UE while a first radio of the first UE is in a sleep mode.

An apparatus for wireless communications at a network entity is described. The apparatus may include a processor, memory coupled with the processor, and instructions stored in the memory. The instructions may be executable by the processor to cause the apparatus to receive, from a first UE, an indication of a UE type of the first UE and transmit, to the first UE, control signaling indicating a configuration associated with a set of sidelink communication resources for receiving signaling from a second UE while a first radio of the first UE is in a sleep mode.

Another apparatus for wireless communications at a network entity is described. The apparatus may include means for receiving, from a first UE, an indication of a UE type of the first UE and means for transmitting, to the first UE, control signaling indicating a configuration associated with a set of sidelink communication resources for receiving signaling from a second UE while a first radio of the first UE is in a sleep mode.

A non-transitory computer-readable medium storing code for wireless communications at a network entity is described. The code may include instructions executable by a processor to receive, from a first UE, an indication of a UE type of the first UE and transmit, to the first UE, control signaling indicating a configuration associated with a set of sidelink communication resources for receiving signaling from a second UE while a first radio of the first UE is in a sleep mode.

Some examples of the method, apparatuses, and non-transitory computer-readable medium described herein may further include operations, features, means, or instructions for transmitting, to the second UE, second control signaling indicating to transmit a wake up signal to the first UE in accordance with the configuration and communicating with the first UE based on transmitting the second control signaling.

In some examples of the method, apparatuses, and non-transitory computer-readable medium described herein, transmitting the control signaling may include operations, features, means, or instructions for transmitting an indication of a first subset of the set of sidelink communication resources associated with wake up signals for communications with the network entity and a second subset of the set of sidelink communication resources associated with wake up signals for communications with other UEs.

In some examples of the method, apparatuses, and non-transitory computer-readable medium described herein, transmitting the control signaling may include operations, features, means, or instructions for transmitting an indication of one or more of a first discontinuous reception configuration associated with the first subset and a second discontinuous reception configuration associated with the second subset.

In some examples of the method, apparatuses, and non-transitory computer-readable medium described herein, transmitting the control signaling may include operations, features, means, or instructions for transmitting an indication of the configuration per resource pool, where the set of sidelink communication resources includes a resource pool of a set of multiple resource pools associated with a bandwidth part associated with sidelink communications for the first UE.

In some examples of the method, apparatuses, and non-transitory computer-readable medium described herein, the set of sidelink communication resources includes a resource pool and the configuration includes a set of reference signal monitoring occasions for the resource pool, a set of synchronization signal monitoring occasions for the resource pool, a set of wake up signal monitoring occasions, or a combination thereof.

Some examples of the method, apparatuses, and non-transitory computer-readable medium described herein may further include operations, features, means, or instructions for receiving, from the first UE, an indication of a quantity of resource pools the UE may be capable of supporting in the sleep mode, where the configuration may be based on the indication of the quantity of resource pools the UE may be capable of supporting in the sleep mode.

In some examples of the method, apparatuses, and non-transitory computer-readable medium described herein, transmitting the control signaling may include operations, features, means, or instructions for transmitting an indication of whether a reference signal, a synchronization signal, or a combination thereof may be enabled for a resource pool corresponding to the set of sidelink communication resources.

In some examples of the method, apparatuses, and non-transitory computer-readable medium described herein, transmitting the control signaling may include operations, features, means, or instructions for transmitting an indication that a synchronization signal may be enabled for a resource pool corresponding to the set of sidelink communication resources, where the synchronization signal may be located outside of the resource pool.

In some examples of the method, apparatuses, and non-transitory computer-readable medium described herein, transmitting the control signaling may include operations, features, means, or instructions for transmitting an indication of a set of multiple resource pools for sidelink communications, where the set of sidelink communication resources include a resource pool of the set of multiple resource pools.

In some examples of the method, apparatuses, and non-transitory computer-readable medium described herein, transmitting the control signaling may include operations, features, means, or instructions for transmitting an indication that the configuration may be associated with the second UE.

In some examples of the method, apparatuses, and non-transitory computer-readable medium described herein, transmitting the control signaling may include operations, features, means, or instructions for transmitting an indication that the configuration may be associated with a first sub-resource pool of a resource pool for sidelink communications, where the set of sidelink communication resources includes the first sub-resource pool, and where a guard band separates the first sub-resource pool from a second sub-resource pool of the resource pool.

In some examples of the method, apparatuses, and non-transitory computer-readable medium described herein, transmitting the control signaling may include operations, features, means, or instructions for transmitting an indication of a set of multiple configurations associated with the set of sidelink communication resources, the set of multiple configurations including the configuration.

### BRIEF DESCRIPTION OF THE DRAWINGS

FIG. 1 illustrates an example of a wireless communications system that supports low power wake up radio in sidelink communications in accordance with one or more aspects of the present disclosure.

FIG. 2 illustrates an example of a block diagram of a device that supports low power wake up radio in sidelink communications in accordance with one or more aspects of the present disclosure.

FIG. 3 illustrates an example of a wireless communication system that supports low power wake up radio in sidelink communications in accordance with one or more aspects of the present disclosure.

FIG. 4 illustrates an example of a configuration diagram that supports low power wake up radio in sidelink communications in accordance with one or more aspects of the present disclosure.

FIG. 5 illustrates an example of a configuration diagram that supports low power wake up radio in sidelink communications in accordance with one or more aspects of the present disclosure.

FIG. 6 illustrates an example of a configuration diagram that supports low power wake up radio in sidelink communications in accordance with one or more aspects of the present disclosure.

FIG. 7 illustrates an example of a configuration diagram that supports low power wake up radio in sidelink communications in accordance with one or more aspects of the present disclosure.

FIG. 8 illustrates an example of a resource diagram that supports low power wake up radio in sidelink communications in accordance with one or more aspects of the present disclosure.

FIG. 9 illustrates an example of a resource diagram that supports low power wake up radio in sidelink communications in accordance with one or more aspects of the present disclosure.

FIG. 10 illustrates an example of a slot format that supports low power wake up radio in sidelink communications in accordance with one or more aspects of the present disclosure.

FIG. 11 illustrates an example of a process flow that supports low power wake up radio in sidelink communications in accordance with one or more aspects of the present disclosure.

FIGS. 12 and 13 show block diagrams of devices that support low power wake up radio in sidelink communications in accordance with one or more aspects of the present disclosure.

FIG. 14 shows a block diagram of a communications manager that supports low power wake up radio in sidelink communications in accordance with one or more aspects of the present disclosure.

FIG. 15 shows a diagram of a system including a device that supports low power wake up radio in sidelink communications in accordance with one or more aspects of the present disclosure.

FIGS. 16 and 17 show block diagrams of devices that support low power wake up radio in sidelink communications in accordance with one or more aspects of the present disclosure.

FIG. 18 shows a block diagram of a communications manager that supports low power wake up radio in sidelink communications in accordance with one or more aspects of the present disclosure.

FIG. 19 shows a diagram of a system including a device that supports low power wake up radio in sidelink communications in accordance with one or more aspects of the present disclosure.

FIGS. 20 through 25 show flowcharts illustrating methods that support low power wake up radio in sidelink communications in accordance with one or more aspects of the present disclosure.

### DETAILED DESCRIPTION

Some user equipments (UE)s may include a wake up radio receiver in addition to a main radio. The wake up radio monitors for wake up signals, low power reference signals (for channel estimation), and/or low power synchronization signals (for synchronization) while the UE is in a sleep mode. The wake up radio receiver uses less power than the main radio, and accordingly inclusion of a wake up radio saves power at the UE when the UE is in a sleep mode. A network entity may wake up a UE via transmitting a wake up signal to the UE, and then the UE may communicate with the network entity or via sidelink with another UE. Another UE may also transmit a wake up signal to a UE in a sleep mode. The network entity may indicate resources (e.g., a bandwidth part (BWP) that includes resource pools) that are available for sidelink communications. In sidelink mode 1, a network entity schedules resources for sidelink transmissions between UEs. In sidelink mode 2, the UEs autonomously select sidelink resources from the configured resource pools, based on reference signal received power (RSRP) measurements for the different resource pools. If a UE is out of range of the network entity, the network entity may be unable to directly assign sidelink resources to the UE.

Aspects of the present disclosure relate to configuring communication resources that support low power wake up radio in sidelink communications. For example, some aspects relate to configurations of sidelink communication resources that support low power wake up radio in sidelink communications. A network entity indicates a configuration for a UE for wake up radio signaling when the main radio of the UE is in a sleep mode. The UE may then monitor for and receive, using the wake up radio, a wake up signal, a low power reference signal, or a low power synchronization signal from a second UE in accordance with the configuration. If the UE receives a wake up signal from the second UE, the UE may establish communications with the second UE or with the network entity based on the wake up signal. In some cases, the configuration may be for a sidelink BWP for the UE, and the configuration may indicate a resource pool for wake up radio signaling. In some cases, the network entity may indicate multiple dedicate resource pools within a BWP that may be used for wake up radio signaling. In some cases, the network entity may indicate sub-resource pools within each resource pool of a BWP that may be used for wake up radio signaling. In some cases, the wake up signaling resources may be shared with the main radio resources. Per resource pool or per sub-resource pool, the configuration may indicate monitoring occasions for low-power reference signals, monitoring occasions for low power synchronization signals, monitoring occasions for wake up signals, and partitioning of the resources dedicated for wake up signaling from resources dedicated for main radio communications. In some examples, the configuration of wake up radio signaling resources may be based on the class or type of UE, which the UE may report to the network entity.

Aspects of the disclosure are initially described in the context of wireless communications systems. Aspects of the disclosure are additionally illustrated with reference to block diagrams, configuration diagrams, resource diagrams, and process flows. Aspects of the disclosure are further illustrated by and described with reference to apparatus diagrams, system diagrams, and flowcharts that relate to low power wake up radio in sidelink communications.

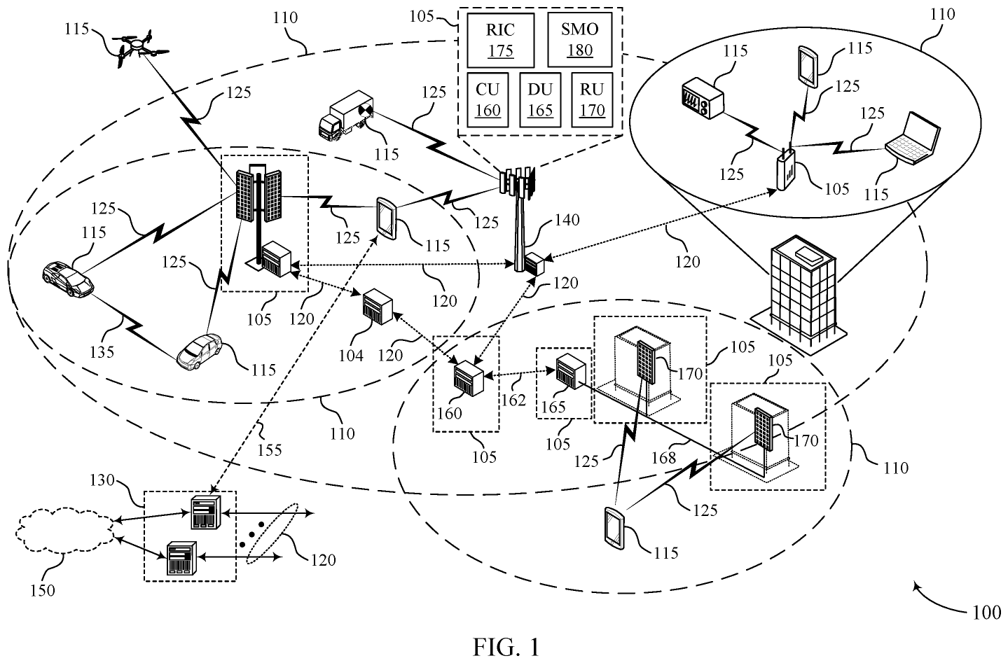

FIG. 1 illustrates an example of a wireless communications system 100 that supports low power wake up radio in sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support low power wake up radio in sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may include a wake up radio receiver in addition to a main radio. The wake up radio may monitor for wake up signals, low power reference signals (for channel estimation), and/or low power synchronization signals (for synchronization) while the UE 115 is in a sleep mode. The wake up radio receiver uses less power than the main radio, and accordingly inclusion of a wake up radio saves power at the UE 115 when the UE 115 is in a sleep mode. A network entity 105 may wake up a UE 115 via transmitting a wake up signal to the UE 115, and then the UE 115 may communicate with the network entity 105 or via sidelink with another UE 115. Another UE 115 may also transmit a wake up signal to a UE 115 in a sleep mode. The network entity 105 may indicate resources (e.g., a BWP that includes resource pools) that are available for sidelink communications. In sidelink mode 1, a network entity 105 schedules resources for sidelink transmissions. In sidelink mode 2, the UEs 115 autonomously select sidelink resources from the configured resource pools, based RSRP measurements for the different resource pools. If a UE 115 is out of range of the network entity, the network entity 105 may be unable to directly assign sidelink resources to the UE 115.

A network entity 105 indicates a configuration for a UE 115 for wake up radio signaling when the main radio of the UE 115 is in a sleep mode. The UE 115 may then monitor for and receive, using the wake up radio, a wake up signal, a low power reference signal, or a low power synchronization signal from a second UE 115 in accordance with the configuration. If the UE 115 receives a wake up signal from the second UE 115, the UE 115 may establish communications with the second UE 115 or with the network entity 105 based on the wake up signal. In some cases, the configuration may be for a sidelink BWP for the UE 115, and the configuration may indicate a resource pool for wake up radio signaling. In some cases, the network entity 105 may indicate multiple dedicate resource pools within a BWP that may be used for wake up radio signaling. In some cases, the network entity 105 may indicate sub-resource pools within each resource pool of a BWP that may be used for wake up radio signaling. In some cases, the wake up signaling resources may be shared with the main radio resources. Per resource pool or per sub-resource pool, the configuration may indicate monitoring occasions for low-power reference signals, monitoring occasions for low power synchronization signals, monitoring occasions for wake up signals, and partitioning of the resources dedicated for wake up signaling from resources dedicated for main radio communications. In some examples, the configuration of wake up radio signaling resources may be based on the class or type of UE 115, which the UE 115 may report to the network entity.

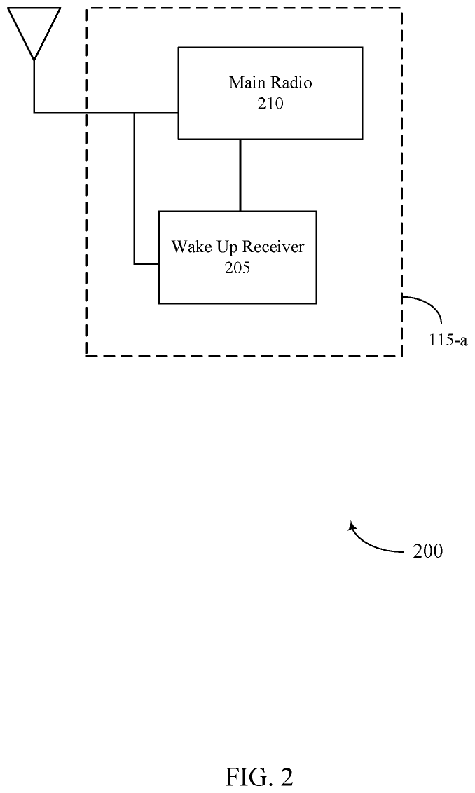

FIG. 2 illustrates an example of a block diagram 200 that supports low power wake up radio in sidelink communications in accordance with one or more aspects of the present disclosure. The block diagram 200 may implement aspects of the wireless communication system 100. As described herein, some wireless communications systems 100 may include a UE 115-a that includes a wake up radio receiver (or wake up radio) 205 in addition to a main radio 210.

In some examples, the wake up radio 205 may monitor for wake up signals, low power reference signals (for channel estimation), and/or low power synchronization signals (for synchronization) while the main radio 210 is in a sleep state. The wake up radio 205 may use less power than the main radio 210, and accordingly inclusion of the wake up radio 205 saves power at the UE 115-a when the UE 115-a is in the sleep mode. In some examples, the wake up radio 205 may be powered separately from the main radio 210 and powered by less power consuming blocks. In some examples, the wake up radio 205 may wake up the main radio 210 when actual communication is needed. The wake up radio 205 may reduce total power consumption by the UE 115-a by avoiding unnecessary wake up of the main radio 210 which may be associated with a higher power consumption. In some examples, the wake up radio 205 may reduce latency. For example, since the wake up radio 205 consumes low power, the wake up radio 205 may more frequently monitor for wake up signals reducing average latency while maintaining low power consumption.

In some examples, the main radio 210 may be a single modem with different firmware, software, and/or hardware for sidelink interface and the Uu interface. In some examples, the main radio 210 may include separate modems for the sidelink interface and the Uu interface (in some example, with some common components, and in some examples, with no common components).

In some examples, the UE 115-a with the wake up radio 205 and the main radio 210 may be used for Internet of Things (IoT) applications. For IoT applications, there may be a tradeoff between latency and power consumption. In some examples, IoT applications may have low power requirements that are latency tolerate, such as periodic sensing and metering use cases. For low power requirements, the duty cycle, or the proportion of time during which the main radio 210 is operated, is minimized with longer latency to extend battery life of the UE 115-a. In some examples, IoT applications may have lower latency requirements, such as actuator control, on-demand sensing where the case age of the sensed information matters, and on-demand location tracking. In the lower latency requirement examples, achieving the lower latency may increase power consumption. Using the UE 115-a with the wake up radio 205 and the main radio 210 for IoT applications may provide lower latency and lower power consumption than UEs 115 without the wake up radio 205.

In some examples, the wake up signal may be designed with a scalable bandwidth. Larger wake up signal bandwidth increases power consumption, and therefore in some examples narrower bandwidth may be used. In some examples, the wake up signal may support repetitions to improve coverage. In some examples, configurable frequency guard bands separate the wake up signal from other signals. The guard bands may be used to improve the filtering performance of the wake up radio 205 receiving the wake up signal. In some examples, the minimum guard band may be specified by the UE 115-a (e.g., in control signaling transmitted to another UE 115 or to a network entity 105). In some examples, the wake up signal may be designed with different modulation and waveforms considering different use cases. For example, on-off key (OOK) sequence-based signals carried on a waveform such as orthogonal frequency-division multiplexing (OFDM) may be used for ultra-low power IoT applications due to the low power requirements of OOK signaling. As another example, quadrature phase shift keying (QPSK) sequence-based signal carried on a waveform may be used for low power eMBB or extended reality (XR) applications. In some examples, the wake up signal may be designed with an OFDM-based waveform or an OOK based waveform. For the OFDM-based waveform design, the wake up radio 205 processes the wake up signal at base band and the wake up radio 205 may use main radio 210 to receive the wake up signal. For the OOK-based waveform design, the wake up radio 205 uses an envelope detector (e.g., low intermediate frequency (IF) to process the wake up signal and the wake up radio 205 is a separate receiver from the main radio 210. For the OOK-based waveform design, Manchester code may be used to simplify receiver implementation, to improve resilience to interference, and to ensure 50% duty cycle and avoid long periods of 0's. The OOK-based waveform design for the wake up signal provides a larger power savings that the OFDM-based waveform design.

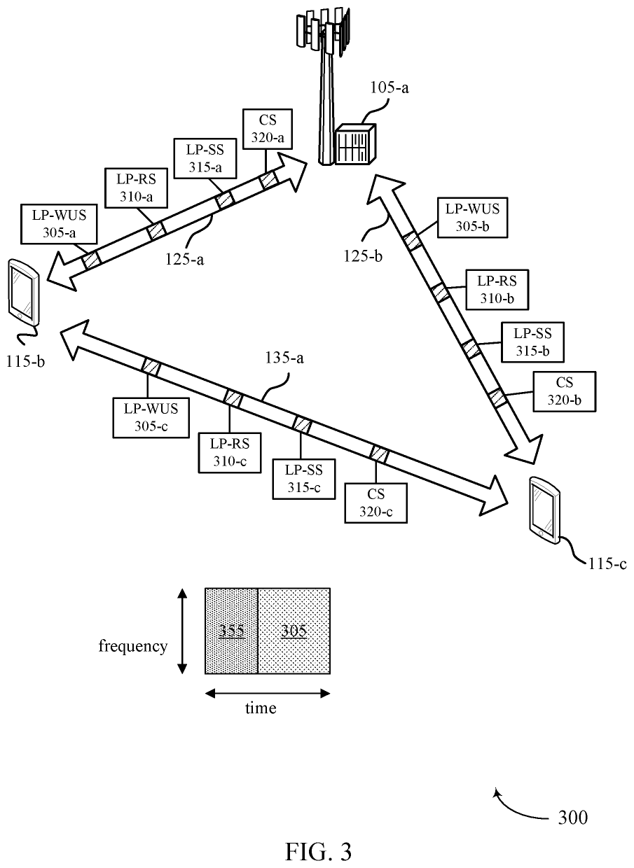

FIG. 3 illustrates an example of a wireless communications system 300 that supports low power wake up radio in sidelink communications in accordance with one or more aspects of the present disclosure. The wireless communications system 300 may implement aspects of the wireless communications system 100. For example, the wireless communications system 300 may include a UE 115-b and a UE 115-c which may be examples of a UE 115 described herein. The wireless communications system 300 may include a network entity 105-a which may be an example of a network entity 105 described herein. In some examples, one or both of the UE 115-b and a UE 115-c may include a wake up radio 205 and a main radio 210.

The UE 115-b may communicate with the network entity 105-a using a communication link 125-a, which may be an example of an NR or LTE link between the UE 115-b and the network entity 105-a. The UE 115-c may communicate with the network entity 105-a using a communication link 125-b, which may be an example of an NR or LTE link between the UE 115-c and the network entity 105-a. The communication link 125-a and the communication link 125-b may include bi-directional links that enables both uplink and downlink communication. For example, the UE 115-b may transmit uplink transmissions, such as uplink control signals or uplink data signals, to the network entity 105-a using the communication link 125-a and the network entity 105-a may transmit downlink transmissions, such as downlink control signals or downlink data signals, to the UE 115-b using the communication link 125-a. The UE 115-c may transmit uplink transmissions, such as uplink control signals or uplink data signals, to the network entity 105-a using the communication link 125-b and the network entity 105-a may transmit downlink transmissions, such as downlink control signals or downlink data signals, to the UE 115-c using the communication link 125-b.

The UE 115-b may communicate with the UE 115-c using a sidelink communication link 135-a. The sidelink communication link 135-a may include bi-directional links that enable the UE 115-b and the UE 115-c to transmit and receive sidelink signals. In some examples (e.g., in Mode 1), the network (e.g., the network entity 105-a) may configure resources for the sidelink communication link 135-a. In some examples, the UE 115-b and the UE 115-c may communicate over the sidelink communication link 135-a using directional communications techniques (e.g., beamforming techniques). In some examples (e.g., in Mode 2), the UE 115-b and the UE 115-c may determine and configure the resources for the sidelink communication link 135-a autonomously (e.g., without involvement from the network entity 105-a).

In some examples, the network entity 105-a may transmit low power (LP) wake up signals (LP-WUS)s 305-a, an LP synchronization signal associated with a LP-WUS 305-a, (e.g., a LP synchronization signal may be transmitted in a preamble 355 of an LP-WUS 305) low power reference signals (LP-RS) 310-a, low power synchronization signals (LP-SS) 315-a and/or control signals (CS) 320-a to UE 115-b via communication link 125-a. Similarly, the network entity 105-a may transmit LP-WUS 305-b, an LP synchronization signal associated with a LP-WUS 305-b, LP-RS 310-b, LP-SS 315-b and/or CS 320-b to UE 115-b via communication link 125-b. In some examples, the UE 115-a may transmit LP-WUS 305-c, an LP synchronization signal associated with a LP-WUS 305-c, LP-RS 310-c, LP-SS 315-c and/or CS 320-c to the UE 115-b via sidelink communication link 135-a or vice versa.

In some cases, the UE 115-b may wake up the UE 115-c, for example if the UE 115-c is out of range of the network entity 105-a or at a cell edge. In sidelink, one BWP may contain multiple receiving an transmitting resource pools, and physical layer channels may be configured per resource pool. In sidelink mode 1, sidelink resources are scheduled by the network entity 105-a. The network entity 105-a assigns resources for sidelink transmissions. Both dynamic allocation via downlink control information (DCI) format 3-x and configured transmissions (Type-1 and Type-2) may be supported. In sidelink mode 2, the UEs (the UE 115-b and the UE 115-c) may autonomously select sidelink resources from a configured (pre-configured) sidelink resource pool(s) based on channel sensing mechanism. A UE (e.g., the UE 115-b and the UE 115-c) may sense resources from the resource pool. Based on the outcome of the sensing (e.g., priority of different transmissions and RSRP), a UE (e.g., the UE 115-b and the UE 115-c) may select resources from the configured resource pool for a transmission. For an in coverage UE, the network entity 105-a may configure the UEs (e.g., the UE 115-b and the UE 115-c) to adopt mode 1 or mode 2. For an out of coverage UE (e.g., if the UE 115-c is out of range), the out of coverage UE may operate in mode 2 and not mode 1.

In some examples, the LP-WUS (305-a, 305-b, 305-c), an LP synchronization signal associated with an LP-WUS 305, the LP-RS (310-a, 310-b, 310-c), and the LP-SS (315-a, 315-b, 315-c) may have a configuration including: 1) a type of signal; 2) type of waveform; 3) modulation information applied to time domain or frequency domain; 4) periodicity of signals for LP-RS and LP-SS or monitoring occasions in case of LP-WUS with discontinuous reception (DRX) cycle if DRX is configured for low power wake up radio (LP-WUR) or periodicity of LP-WUS if DRX is not configured for LP-WUR; 5) repetition of signals (e.g., a signal of a number of time resources and frequency resources is repeated a configurable number of times); and/or 6) time/frequency sizes (e.g., number of time symbols or time units or time elements and frequency elements or frequency units such as resource element or resource blocks (RB)s or subchannels). In some examples, the configuration for the LP-WUS (305-a, 305-b, 305-c) may configure an associated LP synchronization signal (e.g., which may be transmitted in a preamble 355 before a LP-WUS 305).

For resources for wake up radio signaling, several options may be configured (e.g., via RRC signaling (e.g., in control signals 320-a or 320-b)). In a first option, a dedicated BWP with dedicated resource pools for LP-WUR, including LP-WUS, LP-RS (used for channel estimation), or LP-SS (used for synchronization). In a second option, dedicated resources within a BWP for LP-WUR may be configured. In a third option, a dedicated sub resource pool (e.g., a portion of the resource pool) of each resource pool within a BWP may be configured for LP-WUR. In a fourth option, the LP-WUR may share a resource pool with the main radio. Each option may be configured per UE class or type, and different configurations may be used for different types of UEs (e.g., which subcarrier spacing, bandwidth the UE type supports in LP-WUR). The configuration per resource pool may include at least one of: 1) LP-RS (similarly to CSI-RS or tracking reference signal (TRS) for main radio) configuration and monitoring occasions; 2) LP-SS (similar to synchronization signal block (SSB) for main radio) configuration and monitoring occasions; 3) LP-WUS configuration and monitoring occasions; and 4) partitioning of the resource pool and sub resource pool configuration, if the configuration is for a sub resource pool.

In some examples, the configuration for the type of signal for LP-WUS may be a channel encoded transmission (e.g., as in physical downlink control channel (PDCCH) based DCI with a polar coding for the channel coding). In some examples, the configuration for the type of signal for LP-WUS or LP-RS or LP-SS may be a sequence-based transmission (e.g., OOK, amplitude-shift keying (ASK), phase-shift keying (PSK), quadrature amplitude modulation (QAM), frequency-shift keying (FSK), Chirp, Zadoff, pulse position modulation (PPM), pulse amplitude modulation (PAM), pulse width modulation (PWM), Gaussian, Bernoulli, Gold, discrete Fourier transform (DFT), Reed-Solomon, Walsh [Hadamard] transmission) (e.g., as in CSI-RS, sounding reference signal (SRS), demodulation reference signal (DMRS), SSB primary synchronization signal (PSS) or secondary synchronization signal (SSS), etc.). In some examples, the configuration for the type of signal for LP-WUS, LP-RS, or LP-SS may be a sequence-based OOK signal carried on a waveform such as OFDM or single carrier or others.

In some examples, the configuration for the waveform for LP-WUS, LP-RS, or LP-SS may be OFDM versus single carrier or DFT spread OFDM or single-carrier quadrature amplitude modulation (SC-QAM) versus others. In some examples, the configuration for the modulation information LP-WUS, LP-RS, or LP-SS may be OOK (e.g., using Manchester coding or differential coding), ASK, PSK, QAM, FSK, Chirp, Zadoff, PPM, PAM, PWM, Gaussian, Bernoulli, Gold, DFT, Reed-Solomon, Walsh (Hadamard) or others.

In some examples, the LP-WUS may be a coded control signal, such as DCI, similar to a new radio wake up signal (e.g., PDCCH-based DCI with polar coding). In some examples, the LP-WUS may be a sequence based signal (e.g., DFT, Gold, ASK, PSK, PPM, PWM, PAM, Walsh, m-seq, Zadoff, Reed Solomon) with a format similar to physical uplink communication channel (PUCCH) format 0 or the LP-WUS may be a time-domain sequence based signal which is modulating the time domain signal with a sequence. In some examples, the LP-WUS may be an OOK-based waveform signal with OFDM waveform modulating the time domain signal with low and high voltage signals.

In some examples, the LP-RS may be a sequence based signal (e.g., DFT, Gold, ASK, PSK, PPM, PWM, PAM, Walsh, m-seq, Zadoff, Reed Solomon) similar to DMRS, CSI-RS, SRS or TRS or the LP-RS may be a time-domain sequence based signal which is modulating the time domain signal with a sequence. In some examples, the LP-RS may be an OOK-based waveform signal, with OFDM waveform or DFT-s-OFDM or single carrier or SC-QAM, modulating the time domain signal with different voltage.

In some examples, the LP-SS may be a sequence based signal similar to SSB's PSS or SSB's SSS or time-domain sequence based signal which is modulating the time domain signal with a sequence. In some examples, the LP-RS may be an OOK-based waveform signal, with OFDM waveform, modulating the time domain signal with low and high voltage signals.

In some examples (e.g., in high-frequency or wide-band communications), some devices may use OFDM signals while some other devices may use OOK signals. In such cases, OFDM and OOK signals may be required to coexist in the same wireless spectrum (e.g., a same high-frequency spectrum). As such, the transmitter may multiplex an OOK-based waveform with other OFDM waveforms (e.g., to achieve power savings for the receiver that receives the OOK-based waveform). Additionally, or alternatively, a transmitter (e.g., a network entity 105-a) may transmit both an OOK signal and an OFDM signal, where a first receiver (e.g., a UE 115-b) may receive the OOK signal and a second receiver (e.g., a UE 115-c) may receive an OFDM signal. Alternatively, in an uplink scenario, the first receiver (e.g., a UE 115-b) and second receiver (e.g., a UE 115-c) may transmit an OOK signal and an OFDM signal, respectively, however the receiver may receive the OOK and OFDM signals on a same band (e.g., on different resource blocks or resource elements of the same band).

In some examples, a waveform generator (e.g., an OFDM waveform generator) may generate OFDM waveform that includes an OOK waveform with a particular frequency range. For example, the waveform generator may generate an OFDM symbol-based OOK waveform. In such examples, the transmitter may turn the waveform generator ON and OFF to generate an ON-OFF pattern across multiple OFDM symbols. However, such OFDM symbol-based OOK waveforms may have a relatively high granularity (e.g., being based on one OFDM symbol). In addition, the transmitter may be unable to transmit other non-OFDM waveforms to other receiving devices using the OFDM symbol-based OOK waveforms. Alternatively, the waveform generator may generate sub-OFDM symbol-based waveform. In such examples, the transmitter may zero out half (e.g., a first half or a second half) of an OFDM symbol in a time domain to generate an ON-OFF pattern within an OFDM symbol. However, such sub-OFDM symbol-based waveforms may introduce a bandwidth regrowth problem as the bandwidth of the sub-OFDM symbol may expand after half of the signal being zeroed out. In cases in which the wireless communications system 300 supports Wi-Fi communications, an access point may generate an OOK signal.

In some aspects, the transmitter may use a Manchester code (e.g., a code with phase encoding (PE)) to generate OOK waveforms. For example, Manchester code may include a line code, for which the transmitter may encode each data bit as a high or low state for an equal amount of time (e.g., 0: ON to OFF, 1: OFF to ON). That is, each data bit may be encoded as a transition from an ON state to an OFF state or a transition from an OFF state to an ON state. In some examples, Manchester code may simplify the design of the receiver by enabling a transmitter to refrain from estimating the detector threshold in the receiver and providing a more robust structure against interference (e.g., no bias, equal quantity of 0s and 1s). That is, the transmitter may use a transition between ON and OFF durations to generate the OOK waveforms, where a receiver may detect a change in power instead of detecting an absolute power of the OOK waveforms. However, using Manchester coding with OFDM-symbol based OOK waveforms, the transmitter may transmit one bit for every two OFDM symbols, which may reduce signaling throughput and spectral efficiency.

For NR communications in the wireless communications system 100 and 300, a transmitter may multiplex other OFDM signals (e.g., in a frequency domain) with an OOK signal. For example, the wireless communications system 100 and 300 may support a transmitter (e.g., a network entity 105 and 105-a) to multiplex one or more OOK waveforms with one or more OFDM waveforms. In some examples, the transmitter may modulate a set of data bits into an OOK sample sequence, which may be a time domain sample sequence, for wireless transmission to a first receiver in a first set of frequency resources. The transmitter may apply a transform to the OOK sample sequence to be represented as a frequency domain sample sequence (e.g., a frequency representation of the OOK sample sequence). Using the frequency domain sample sequence, the transmitter may generate the OOK-based OFDM waveform. In some aspects, the frequency domain sample sequence is mapped to one or more resource elements included in the first set of frequency resources. The transmitter may transmit the OFDM waveform to the first receiver. As such, the receiver may use simple detection schemes (e.g., non-coherent envelope detection) to decode the OOK-modulated OFDM waveform. It should be noted that the techniques described herein may be applied to ASK-based OFDM waveforms directly, in addition to other OFDM waveforms modulated based on other ASK-based signals.

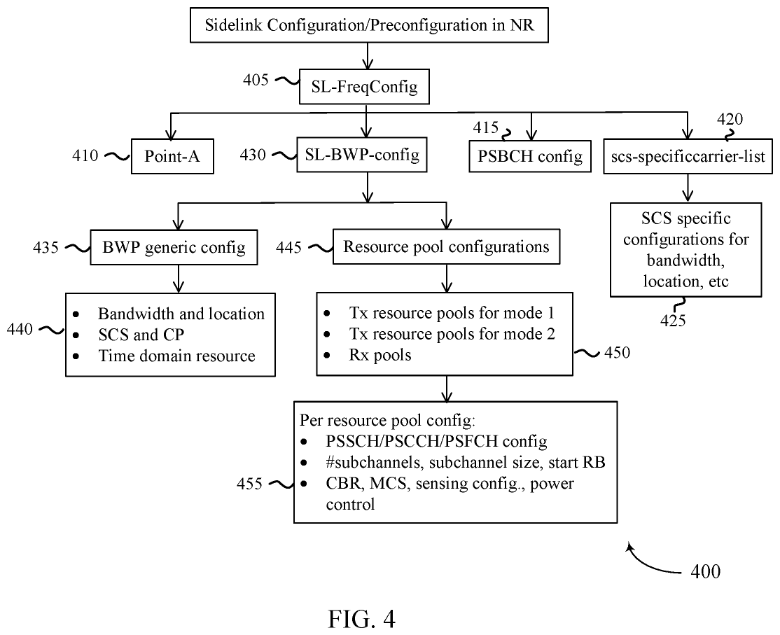

FIG. 4 illustrates an example of a configuration diagram 400 that supports low power wake up radio in sidelink communications in accordance with one or more aspects of the present disclosure. The configuration diagram 400 may implement aspects of the wireless communication system 100 and the wireless communications system 300.

The configuration diagram 400 illustrates an example sidelink configuration or pre-configuration in NR for the sidelink communications between UEs 115 via the sidelink communication link 135. The configuration may be indicated via RRC. The configuration identifies the sidelink frequency configuration 405. In some examples, the sidelink frequency is equivalent of a carrier in Uu. The sidelink frequency configuration 405 may include a Point-A 410 (lowest frequency subband of the sidelink frequency), sidelink BWP configuration 430, physical sidelink broadcast channel (PSBCH) configuration 415, and subcarrier spacing (SCS) specific carrier list 420. The SCS specific carrier list 420 may include SCS specific configurations 425 for bandwidth or location. The sidelink BWP configuration 430 may include a BWP generic configuration 435 with a bandwidth and location, an SCS and cyclic prefix (CP), and time domain resources 440. The sidelink BWP configuration 430 may also include resource pool configurations 445. In some examples, the resource pool configuration in a sidelink BWP includes sixteen receiving pools and eight transmission pool. The resource pool configurations 445 include transmission resource pools for mode 1, resource pools for mode 2 and receiver resource pools 450. The per resource pool configuration 455 may include physical sidelink shared channel (PSSCH), physical sidelink control channel (PSCCH) and physical sidelink feedback channel (PSFCH) configurations, a number of subchannels, a subchannel size, a start RB, a code block rate (CBR), a modulation and coding scheme (MCS), and a sensing configuration and power control. In some examples, one BWP may contain multiple receiving and transmitting resource pools and physical layer channels are configured per resource pool.

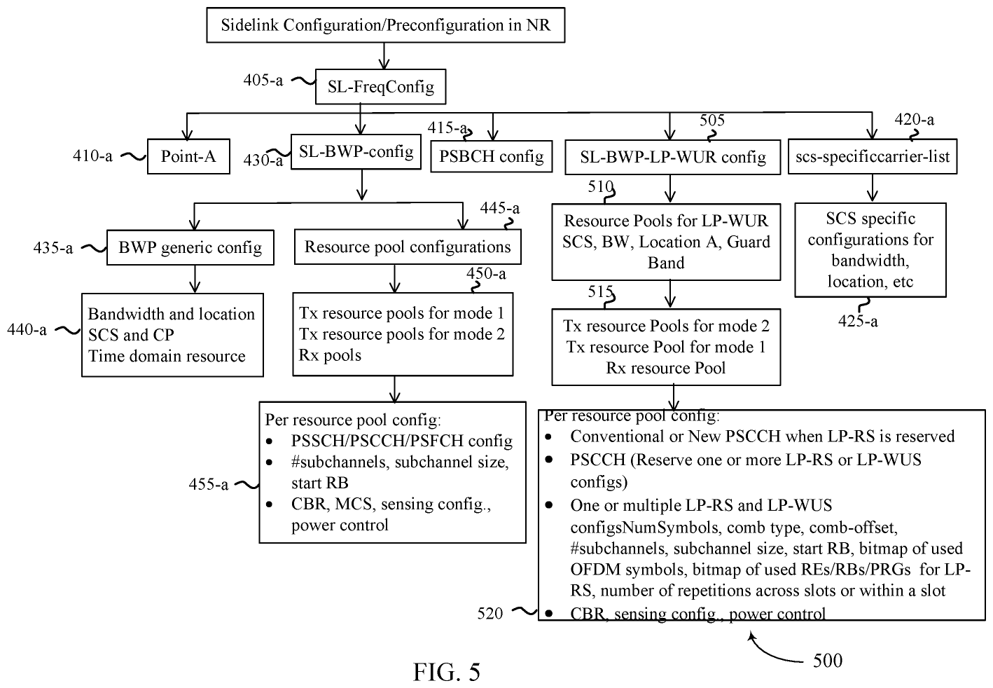

FIG. 5 illustrates an example of a configuration diagram 500 that supports low power wake up radio in sidelink communications in accordance with one or more aspects of the present disclosure. The configuration diagram 500 may implement aspects of the wireless communication system 100 and the wireless communications system 300.

The configuration diagram 500 illustrates an example sidelink configuration or pre-configuration in NR for the sidelink communications between UEs 115 via the sidelink communication link 135. The configuration may be indicated via RRC. In some examples, the configuration includes a dedicated sidelink BWP with dedicated resource pools for LP-WUR including LP-WUS, LP-RR and LP-SS. The configuration identifies the sidelink frequency configuration 405-a. The sidelink frequency configuration 405-a may include a Point-A 410-a (lowest frequency subband of the sidelink frequency), a sidelink BWP configuration 430-a, a PSBCH configuration 415-a, and an SCS specific carrier list 420-a. The SCS specific carrier list 420-a may include SCS specific configurations 425-a for bandwidth or location. The sidelink BWP configuration 430-a may include a BWP generic configuration 435-a with a bandwidth and location, an SCS and cyclic prefix (CP), and time domain resources 440-a. The sidelink BWP configuration 430-a may also include resource pool configurations 445-a. The resource pool configurations 445-a include transmission resource pools for mode 1, resource pools for mode 2 and receiver resource pools 450-a. The per resource pool configuration 455-a may include PSSCH, PSCCH and PSFCH configurations, a number of subchannels, a subchannel size, a start RB, CBR, an MSC, and sensing configuration and power control. In some examples, included in the sidelink frequency configuration is a dedicated sidelink BWP with dedicated resource pools for LP-WUR including LP-WUS, LP-RR and LP-SS shown as sidelink BWP LP-WUR configuration 505. The sidelink BWP LP-WUR configuration 505 may include resource pool configurations 510 for LP-WUR, an SCS, a bandwidth, location A, and a guard band. The resource pool configurations 510 may include transmission resource pools for mode 1, transmission resource pools for mode 2 and receiver resource pools 515. Per resource pool configuration 520 may include PSCCH when LP-RS is reserved, PSCCH (reserve one or more LP-RS or LP-WUS configurations and one or multiple LP-RS and LP-WUS configuration number symbols, a combination type, a comb offset, a number of subchannels, a subchannel size, a start RB, a bitmap of use RE/RBs/PRS for LP-RS, a number of repetitions across slots or within a slot, a CBR, an MSC, a sensing configuration, and a power control.

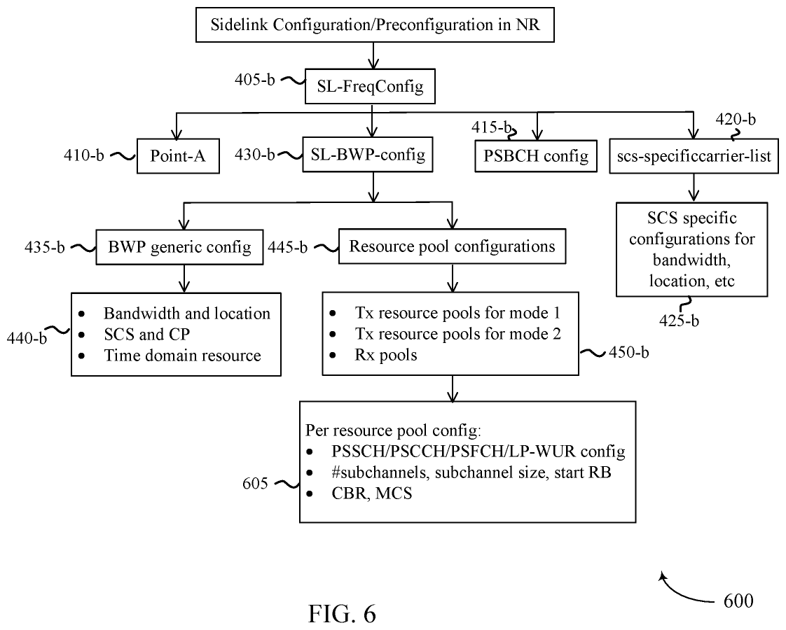

FIG. 6 illustrates an example of a configuration diagram 600 that supports low power wake up radio in sidelink communications in accordance with one or more aspects of the present disclosure. The configuration diagram 400 may implement aspects of the wireless communication system 100 and the wireless communications system 300.

The configuration diagram 600 illustrates an example sidelink configuration or pre-configuration in NR for the sidelink communications between UEs 115 via the sidelink communication link 135. In some examples, the configuration includes dedicated resource pools within a BWP for LP-WUR. The configuration identifies the sidelink frequency configuration 405-b. The sidelink frequency configuration 405-b may include a Point-A 410-b (lowest frequency subband of the sidelink frequency), sidelink BWP configuration 430-b, a PSBCH configuration 415-b, and an SCS specific carrier list 420-b. The SCS specific carrier list 420-b may include SCS specific configurations 425-b for bandwidth or location. The sidelink BWP configuration 430-b may include a BWP generic configuration 435-b with a bandwidth and location, an SCS and CP, and time domain resources 440-b. The sidelink BWP configuration 430-b may also include resource pool configurations 445-b. The resource pool configurations 445-b may include transmission resource pools for mode 1, resource pools for mode 2 and receiver resource pools 450-b. The per resource pool configuration 605 may include dedicated resource pools within the BWP for LP-WUR. In some examples, the per resource pool configuration 605 may include PSSCH, PSCCH, PSFCH and LP-WUR configurations, a number of subchannels, a subchannel size, a start RB, a CBR, an MCS, a sensing configuration, and power control.

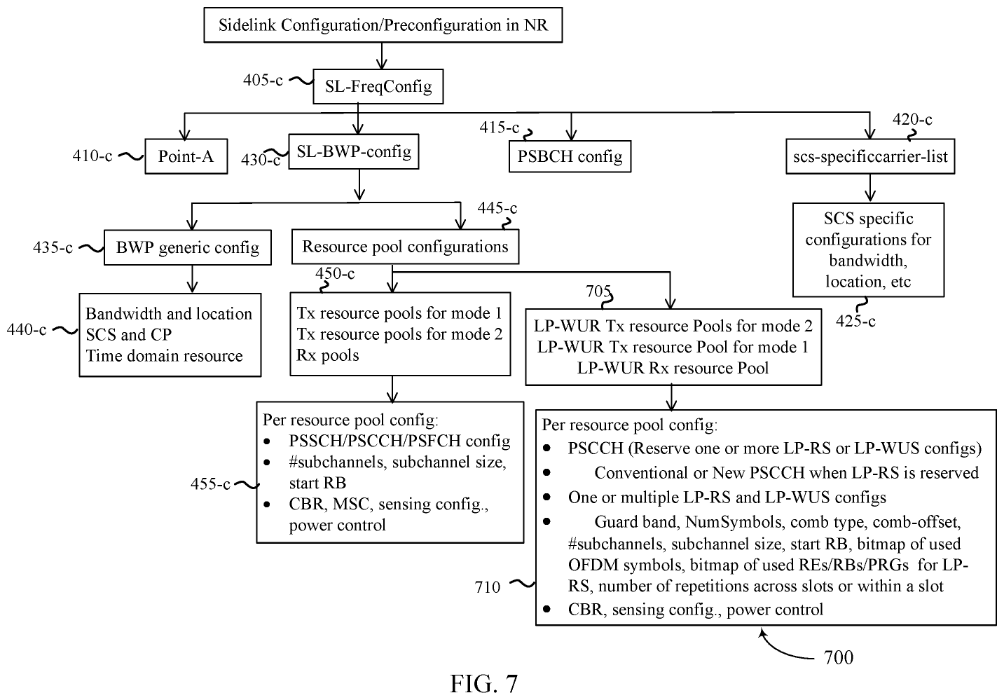

FIG. 7 illustrates an example of a configuration diagram 700 that supports low power wake up radio in sidelink communications in accordance with one or more aspects of the present disclosure. The configuration diagram 400 may implement aspects of the wireless communication system 100 and the wireless communications system 300.

The configuration diagram 700 illustrates an example sidelink configuration or pre-configuration in NR for the sidelink communications between UEs 115 via the sidelink communication link 135. In some examples, the configuration includes dedicated subresource pool (portion of the resource pool) on each resource pool within a BWP for LP-WUR. The configuration identifies the sidelink frequency configuration 405-c. The sidelink frequency configuration 405-c may include a Point-A 410-c (lowest frequency subband of the sidelink frequency), a sidelink BWP configuration 430-c, a PSBCH configuration 415-c, and an SCS specific carrier list 420-c. The SCS specific carrier list 420-c may include an SCS specific configurations 425-c for a bandwidth or location. The sidelink BWP configuration 430-c may include a BWP generic configuration 435-c with bandwidth and location, an SCS and cyclic prefix (CP), and time domain resources 440-c. The sidelink BWP configuration 430-c may also include resource pool configurations 445-c. The resource pool configurations 445-c may include transmission resource pools for mode 1, resource pools for mode 2 and receiver resource pools 450-c. The per resource pool configuration 455-c may include PSSCH, PSCCH and PSFCH configurations, a number of subchannels, a subchannel size, a start RB, a CBR, an MSC, a sensing configuration, and power control. In some examples, the resource pool configurations 445-c may include a dedicated subresource pool (portion of the resource pool) on each resource pool within a BWP for LP-WUR. For example, the resource pool configurations 445-c may include LP-WUR transmission resource pools for model, LP-WUR transmission resource pools for mode 2 and LP-WUR receiver resource pools 705. The per resource pool configuration 710 may include PSCCH with one or more LP-RS or LP-WUS configurations, PSFCH when LP-RS is reserved, one or multiple LP-RS and LP-WUS configurations, a guard band, a number of symbols, a combination offset, a number of subchannels, a subchannel size, a start RB, a bitmap of used resource elements (RE)s, RBs, or physical resource groups (PRG)s for LP-RS, a number of repetitions across slots or within a slot, a CBR, a sensing configuration, and power control.

In some examples, the LP-WUR shares the resource pool with the main radio 210 of the UE 115. In some examples, the sidelink resource configurations may be per UE class or type with different configuration used for different type of UEs. The different types of UEs may be preconfigured or based on defined specification to support low power wake up radio with different resource configurations including SCS and bandwidth.

In some examples, the resource configurations per resource pool may include LP-RS configuration and monitoring occasions similar to CSI-RS or TRS. The resource configurations per resource pool may include LP-SS configurations and monitoring occasions similar to SSB for the main radio. The resource configurations per resource pool may include LP-WUS configurations and monitoring occasions. In some examples, the resource configurations per resource pool may include partitioning of the resource pool and subresource pool configuration.

In some examples, resource configurations for LP-WUR may be preconfigured per UE class or across all UE classes. In some examples, the UE class may provide information about the wake up radio 205 included in the UE class, and some default loaded or preconfigured resource pools, subresource pools and/or BWP for LP-WUR per UE class.

In some examples, a UE 115 may indicate a capability of how many LP-WUR resource pools or subresource pools the UE 115 may support at a given time depending on power consumption and complexity of the wake up radio 205. In some examples, the UE 115 may have only one LP-WUR resource pool or one subresource pool. The capability of how many LP-WUR resource pools or subresource pools may be initially determined per UE class. In some examples, the UE 115 may indicate this capability to the network entity 105, and the network entity 105 and may communicate this capacity of the UE 115 to other UEs 115 that may be communicating with that UE 115. In some examples, the UE 115 may share this capacity of the UE 115 with other UEs 115 during RRC connection or in a form of L1/L2/L3 signaling via the main radio 210 or via the wake up radio 205 if the wake up radio receiver has transmission components.

In some examples, an LP-WUS may indicate to the UE 115 to wake up the main radio 210 (Uu modem) in Uu link. For example, the sidelink communication may be used to wake up the UE for the Uu link or the sidelink communication may be used to for UE-to-UE communication or for both. In some examples, there may be dedicated resources or signals to monitor to wake up Uu modem/interface versus the sidelink modem/interface.

In some examples, the LP-RS may be enabled or disabled per resource pool or per sub resource pool. In some examples, the LP-SS may be enabled or disabled per resource pool or per subresource pool. The LP-SS may be outside any of the resource pools or outside in time dedicated for the resource pools with dedicated location, similar to SSB. In some examples, when the UE 115 is in sleeping mode (light or deep), the UE 115 may deactivate all resource pools or most of the resource pools and monitor one or more of the LP-WUS resource pools.

In some examples, the UE 115 in a connected mode may monitor for LP-WUS on some resource pools with each resource pool having its own LP-WUS configuration, LP-RS configuration, and LP-SS configuration which may include different waveforms, repetitions, periodicity, and/or coding.

In some examples, each pair of UEs 115 may agree on a LP-WUR configuration including one or more of DRX configurations for the wake up radio 205 for performing sidelink or Uu communications. For example, a DRX configuration may include a DRX cycle duration/periodicity and a DRX active time/on duration. A DRX cycle may refer to one cycle of on/active time and off/outside active time.

The UE 115 may be configured with two DRX configurations, where one DRX configuration is for monitoring wake up signals for sidelink communications/interface, and another DRX configuration is for monitoring wake up signals for Uu link communications. In some examples, the sidelink and Uu DRX configurations may be aligned or may be the same. That is, the DRX configuration for LP-WUS monitoring occasions used for sidelink and the DRX configuration used for the Uu link may be aligned for both the sidelink and the Uu link to reduce the complexity of the search at the LP-WUR (e.g., the wake up radio 205) (e.g., for reduced power consumption and reduced complexity). In some examples, there may be similar or different monitoring occasions and DRX for searching for indications to wake up the main radio 210 for sidelink interface or to wake up the main radio 210 to operate the Uu link/interface, when the indication is received from another UE 115.

In some examples, the sidelink resource pool configuration or subresource pool configuration may include two set of configurations, one configuration for waking up the Uu link/interface and another configuration for waking up the sidelink or the PC5 link/interface. The DRX configurations for these two configurations (if the two configurations are not aligned) may be the same or different. The configurations of the type of signals and low power signals (LP-WUR, LP-RS and LP-SS) configurations may be the same or different for the two sets of configurations for waking up Uu and sidelink. In some examples, the guard bands, which assist reliability of receiving the signals may be the same or different for the two sets of configurations. In some cases, Uu wake up may have a higher or lower priority than sidelink based on underlying traffic. These configurations may impact both a sidelink UE 115 waking up the other UE 115 equipped with wake up radio 205 since the UE 115 will have to follow the configuration while sending the different low power signals as well as the UE 115 equipped with wake up radio 205. In some examples, the two monitoring occasions and DRX cycles and signals configurations may be aligned with similar configurations.

In some examples, all configurations of the LP signals (e.g., LP-WUS, LP-RS, LP-SS) and the DRX configurations for waking up UE on Uu link or sidelink may depend on the RRC state/mode of the UE 115 on the Uu link, sidelink, or both. In some examples, the UE 115 may be configured with three DRX configurations: a first DRX configuration to monitor for wake up signals from another UE 115 to wake up the UE 115 for Uu link communication, where a DRX configuration is monitored when the UE 115 is in RRC connected in Uu link; a second DRX configuration for when the UE 115 is in RRC inactive mode/state; and a third DRX configuration for when the UE 115 is in RRC idle mode/state. On a resource pool level or subresource pool level configuration, a UE 115 may be configured with a DRX configuration for each RRC state for the Uu link. Additionally or alternatively, in a similar manner, per resource pool or subresource pool level configuration, a UE 115 may be configured with three DRX configurations to monitor the sidelink wake up signal to wake up for the communications between the UE 115 and other UE 115 when the UE 115 for each RRC state for the PC5 link/interface or sidelink between the two UEs 115. In some cases, all LP signals may be configured differently based on the RRC state of the associated interfaces.

In some examples, the configuration of the LP-WUS, the LP-RS, and/or the LP-SS may include a scrambling identifier (ID) (e.g., for each resource pool or subresource pool, and under each RRC state (e.g., connected/inactive/idle)) to be used: to generate the sequences for the LP-WUS, the LP-RS, and/or the LP-SS, to determine the sequence in the case of the LP-RS, and/or the LP-SS, or to scramble the payload for LP-WUS to determine whether the payload is for the specific UE 115 (to wake up). The scrambling ID may be different based on whether the LP-WUS is for Uu wake up or for sidelink wake up (e.g., unless the DRX configurations for the Uu wake up and for the sidelink wake up are aligned and the same WUS occasions are used for Uu wake up and for the sidelink wake up). For LP-WUS, the scrambling ID may be a radio network temporary identifier for the UE 115.

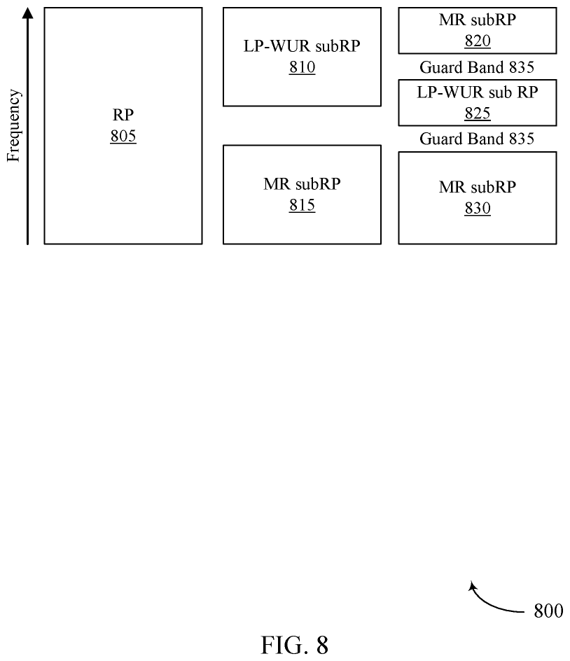

FIG. 8 illustrates an example of a resource diagram 800 that supports low power wake up radio in sidelink communications in accordance with one or more aspects of the present disclosure. The resource diagram 800 may implement aspects of the wireless communication system 100 or the wireless communications system 300.

The resource diagram 800 illustrates one example sidelink resource configuration for LP-WUR. The resource diagram 800 includes a resource pool 805, a LP-WUR subresource pool 810 and a main radio subresource pool 815. The resource diagram further includes main radio subresource pools 820 and 830 separated from a LP-WUR subresource pool 825 by guard bands 835.

In some examples, each pair of UEs 115 for sidelink communication may have their own LP-WUR configuration including one or more resource pools or subresource pools or BWPs for LP-WUR. The guard band 835 for LP-WUR may be defined per resource pool by configuration from the network entity 105. In some examples, the network entity 105 may configure the guard bands 835 based on UEs 115 using the resource pool. In some examples, the network entity 105 signals to each UE 115 the guard band 835 configuration. In some examples, the guard band 835 configuration may be agreed between UEs 115 during RRC connection or through L1/L2/L3 signaling. The guard band 835 may be in resource element granularity, or RB granularity or sub-channel granularity. Subchannel granularity may be in terms of RB lower than or same as current granularity for sidelink. In some examples, the subchannel size may be preconfigured or configured to {10, 15, 20, 35, 50, 75, 100} physical resource blocks (PRBs).

In some examples, the LP-WUS/LP-RS/LP-SS configuration among a set of configurations per resource pool or per subresource pool may be indicated with a defined indication that is based on LP-WUR supported waveforms. The LP-WUS may also carry this indication or the main radio 210 may transmit this indication during main radio 210 being on. In some examples, this indication is a sequence based sidelink control information (SCI) indication (e.g., OOK carried on a waveform, such as single carrier or OFDM, or OFDM based such as current NR waveform) that indicates one or more of the LP-WUS/LP-RS/LP-SS configuration. In some examples, PSSCH symbols may carry the LP-RS or LP-SS.

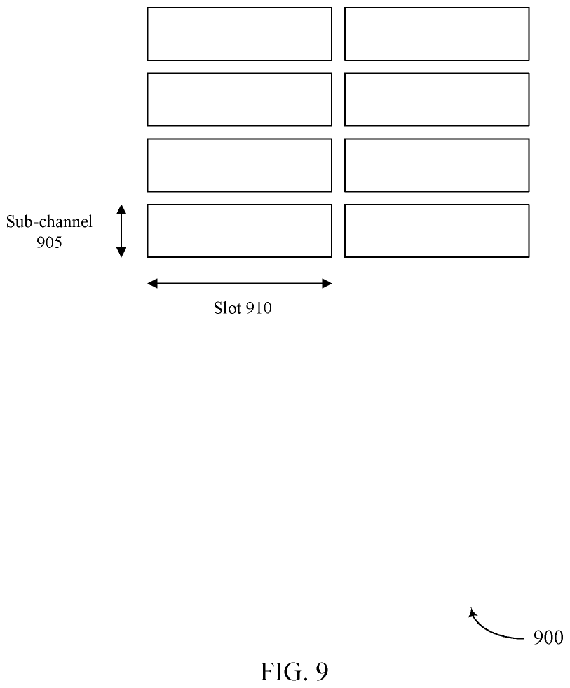

FIG. 9 illustrates an example of a resource diagram 900 that supports low power wake up radio in sidelink communications in accordance with one or more aspects of the present disclosure. The resource diagram 800 may implement aspects of the wireless communication system 100 or the wireless communications system 300.

The resource diagram 800 illustrates one example of a sidelink communication resource configuration. Sidelink communications may occur in transmission and reception resource pools. The minimum resource allocation unit may be a sub-channel 905 in frequency, and a minimum resource allocation in time may be one slot 910. In some examples, some slots are not available for sidelink communications, and some slots contain feedback resources. RRC configuration of resources may be preconfigured (for example, preloaded on the UE 115) or configured by the network entity 105. For sidelink communications, four physical sidelink channels may be defined: PSCCH, PSSCH, PSFCH, and PSBCH. For sidelink communications, multiple reference signals may be defined: DMRS for PSCCH, DMRS for PSSCH, DMRS for PSBCH, CSI-RS, primary synchronization signal (S-PSS), secondary synchronization signal (S-SSS) and phase-tracking reference signal (PTRS) for FR2.

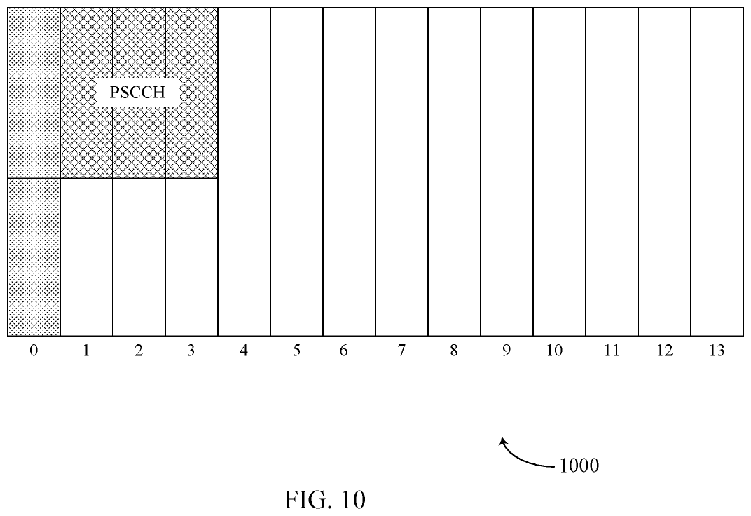

FIG. 10 illustrates an example of a slot format 1000 that supports low power wake up radio in sidelink communications in accordance with one or more aspects of the present disclosure. The slot format 1000 may implement aspects of the wireless communications system 100 or the wireless communications system 300.

The slot format 1000 illustrates an example slot format for sidelink communications. The slot includes 14 OFDM symbols. In some examples, for sidelink communications, the slot may be preconfigured or configured to occupy fewer than 14 symbols. The first symbol 0 may be repeated on the preceding symbol for automatic gain control (AGC) setting. For the slot structure without feedback resources, PSSCH may be in symbols 1-12 with a gap symbol presented after the PSSCH. The PSCCH may be in symbols 1-3 as illustrated. PSCCH and PSSCH may be transmitted in the same slot. Subchannel size may be preconfigured or configured to {10, 15, 20, 25, 50, 75, 100} PRBs. PSCCH and PSSCH may be transmitted in the same slot. For the slot structure with feedback resources, PSSCH may be in symbols 1-9 with a gap symbol presented after the PSSCH. The PSFCH may be in symbols 11-12 with a gap symbol in symbol 13 and a gap symbol in symbol 10. Resources for PSFCH may be configured with a period of {0, 1, 2, 4} slots. The PSFCH symbol may be a repetition of the second symbol for AGC setting. The PSCCH duration may be preconfigured or configured to 2 or 3 symbols, PSCCH may be preconfigured or configured to span {10, 12, 15, 20, 25} PRBs, and may be limited to a single sub-channel. DMRS may be present in every PSCCH symbol and may be placed on every 4th RE. Frequency domain orthogonal cover codes (FD-OCC) may be applied to DMRS to reduce impact of colliding PSCCH transmissions (e.g., the transmitter UE may randomly select from a set of pre-defined FD-OCCs). The starting symbol for PSCCH may be the second symbol in the slot.

In some examples, the SCI may be in two stages for forward compatibility. First stage control (SCI-1) may be transmitted on PSCCH and may contain information for resource allocation and decoding second stage control. Second stage control (SCI-2) may be transmitted on PSSCH and may contain information for decoding data (on PSSCH). Both SCI-1 and SCI-2 may use the PDCCH polar code. SCI-1 content may include priority information (quality of service (QoS) value), PSSCH resource assignment (frequency/time resource for PSSCH), resource reservation period (if enabled), PSSCH DMRS pattern (if more than one patterns are preconfigured or configured), 2nd SCI format (e.g., information on the size of the second SCI), 2-bit beta offset for 2nd-stage control resource allocation, number of PSSCH DMRS port(s): 1 or 2 and 5-bit MCS.

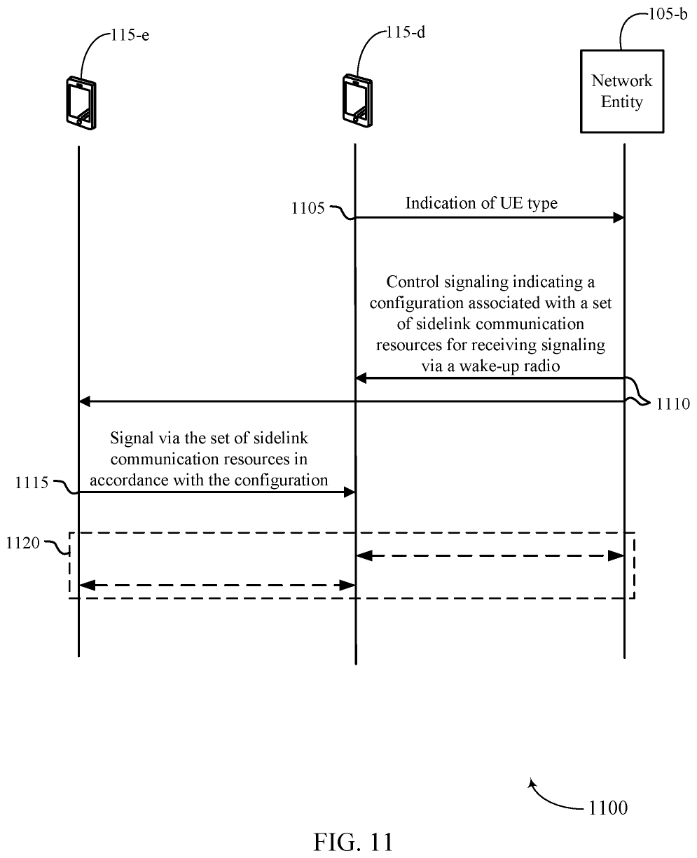

FIG. 11 illustrates an example of a process flow 1100 that supports low power wake up radio in sidelink communications in accordance with one or more aspects of the present disclosure. The process flow 1100 may include a first UE 115-d and a second UE 115-e, which may be an example of a UE 115 as described herein. The process flow 1100 may include a network entity 105-b, which may be an example of a network entity 105 as described herein. In the following description of the process flow 1100, the operations between the network entity 105-b and the first UE 115-d and the second UE 115-e may be transmitted in a different order than the example order shown, or the operations performed by the network entity 105-b and the first UE 115-d and the second UE 115-e may be performed in different orders or at different times. Some operations may also be omitted from the process flow 1100, and other operations may be added to the process flow 1100.

At 1105, the network entity 105-b may receive, from the first UE 115-d, an indication of a UE type of the first UE 115-d.

At 1110, the first UE 115-d and the second UE 115-e may receive, from the network entity 105-b, control signaling indicating a configuration associated with a set of sidelink communication resources for receiving signaling via a wake up radio of the first UE 115-d while the main radio (e.g., a first radio) of the first UE 115-d is in a sleep mode. In some examples, the configuration is based on the indication of the UE type.

At 1115, the first UE 115-d may receive, from the second UE 115-e, while the main radio of the first UE 115-d is in a sleep mode, a signal via the set of sidelink communication resources in accordance with the configuration.

In some examples, at 1120 the first UE 115-d may communicate with one of the network entity 105-b or the second UE 115-e via the main radio based on receiving the signal via the wake up radio at 1115, and the signal is a wake up signal. In some examples, the first UE 115-d may receive, from the network entity 105-b, an indication of a first subset of the set of sidelink communication resources associated with wake up signals for communications with the network entity and a second subset of the set of sidelink communication resources associated with wake up signals for communications with other UEs. In some examples, the first UE 115-d may communicate with the network entity 105-b or the second UE 115-e based on the signal at 1115 being received via the first subset or the second subset. In some examples, the first UE 115-d may receive, from the network entity 105-b, an indication of one or more of a first DRX configuration associated with the first subset and a second DRX configuration associated with the second subset.

In some examples, a first DRX configuration associated with the first subset is associated with a first RRC state (e.g., connected mode of the Uu link) between the first UE and the network entity, a second DRX configuration associated with the first subset is associated with a second RRC state (e.g., inactive mode of the Uu link) between the first UE and the network entity, a third DRX configuration associated with the first subset is associated with a third RRC state (e.g., idle mode of the Uu link) between the first UE and the network entity, a fourth DRX configuration associated with the second subset is associated with a fourth RRC state (e.g., connected mode of the sidelink/PC5) between the first UE and the second UE, a fifth DRX configuration associated with the second subset is associated with a fifth RRC state (e.g., inactive mode of the sidelink/PC5) between the first UE and the second UE, and a sixth DRX configuration associated with the second subset is associated with a sixth RRC state (e.g., idle mode of the sidelink/PC5) between the first UE and the second UE.

In some examples, the first UE 115-d may receive, from the network entity 105-b, an indication of the configuration per resource pool, where the set of sidelink communication resources includes a resource pool of a set of multiple resource pools associated with a BWP associated with sidelink communications for the first UE 115-d.

In some examples, the set of sidelink communication resources includes a resource pool, and the configuration includes a set of reference signal monitoring occasions for the resource pool, a set of synchronization signal monitoring occasions for the resource pool, a set of wake up signal monitoring occasions, or a combination thereof.

In some examples, the first UE 115-d may receive, from a third UE via the wake up radio while the main radio is in the sleep mode, a second signal via a default resource pool in accordance with a default configuration.

In some examples, the first UE 115-d may transmit an indication of a quantity of resource pools the first UE 115-d is capable of supporting via the wake up radio, and the configuration received at 1110 is based on the indication of the quantity of resource pools the first UE 115-d is capable of supporting via the wake up radio.

In some examples, the first UE 115-d may receive an indication of whether a reference signal, a synchronization signal, or a combination thereof is enabled for a resource pool corresponding to the set of sidelink communication resources.

In some examples, the first UE 115-d may receive an indication that a synchronization signal is enabled for a resource pool corresponding to the set of sidelink communication resources, and the synchronization signal is located outside of the resource pool.

In some examples, the first UE 115-d may receive an indication of a set of multiple resource pools for sidelink communications, where the set of sidelink communication resources include a resource pool of the set of multiple resource pools, and the first UE deactivates monitoring of each resource pool of the set of multiple resource pools except for the resource pool while the first radio is in the sleep mode.

In some examples, the first UE 115-d may receive, an indication that the configuration is associated with the second UE 115-e.

In some examples, the first UE 115-d may receive an indication that the configuration is associated with a first sub-resource pool of a resource pool for sidelink communications, where the set of sidelink communication resources includes the first sub-resource pool and a guard band separates the first sub-resource pool from a second sub-resource pool of the resource pool. In some examples, the first UE 115-d may receive, with the control signaling, an indication of a set of multiple configurations associated with the set of sidelink communication resources. In some examples, the first UE 115-d may receive, from the second UE 115-e, second control signaling indicating the configuration from the set of multiple configurations.

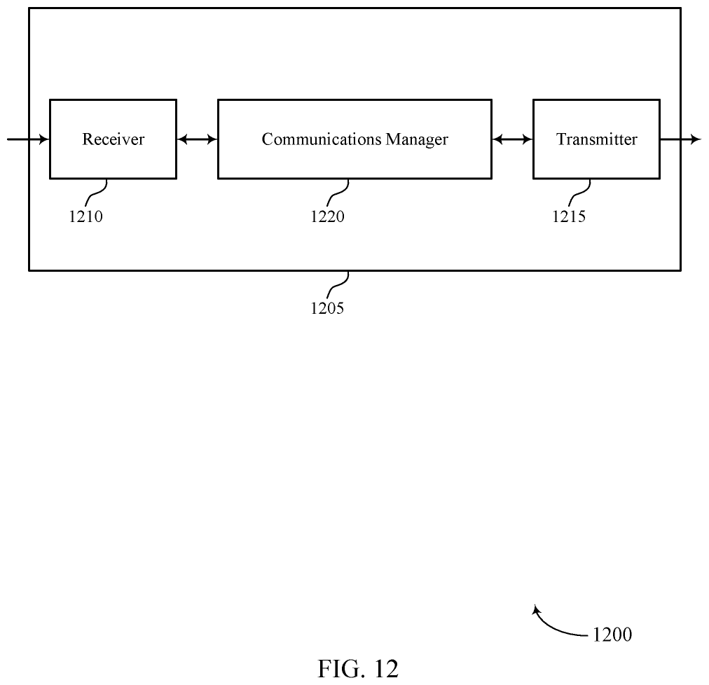

FIG. 12 shows a block diagram 1200 of a device 1205 that supports low power wake up radio in sidelink communications in accordance with one or more aspects of the present disclosure. The device 1205 may be an example of aspects of a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to low power wake up radio in sidelink communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to low power wake up radio in sidelink communications). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of low power wake up radio in sidelink communications as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a first UE in accordance with examples as disclosed herein. For example, the communications manager 1220 may be configured as or otherwise support a means for receiving, from a network entity via a first radio of the first UE, control signaling indicating a configuration associated with a set of sidelink communication resources for receiving signaling via a wake up radio of the first UE while the first radio is in a sleep mode. The communications manager 1220 may be configured as or otherwise support a means for receiving, from a second UE via the wake up radio while the first radio is in the sleep mode, a signal via the set of sidelink communication resources in accordance with the configuration.

Additionally, or alternatively, the communications manager 1220 may support wireless communications at a second UE in accordance with examples as disclosed herein. For example, the communications manager 1220 may be configured as or otherwise support a means for receiving, from a network entity, control signaling indicating a configuration associated with a set of sidelink communication resources for transmitting signaling to a first UE while a first radio of the first UE is in a sleep mode. The communications manager 1220 may be configured as or otherwise support a means for transmitting, to the first UE, a signal via the set of sidelink communication resources in accordance with the configuration.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for more efficient utilization of communication resources.

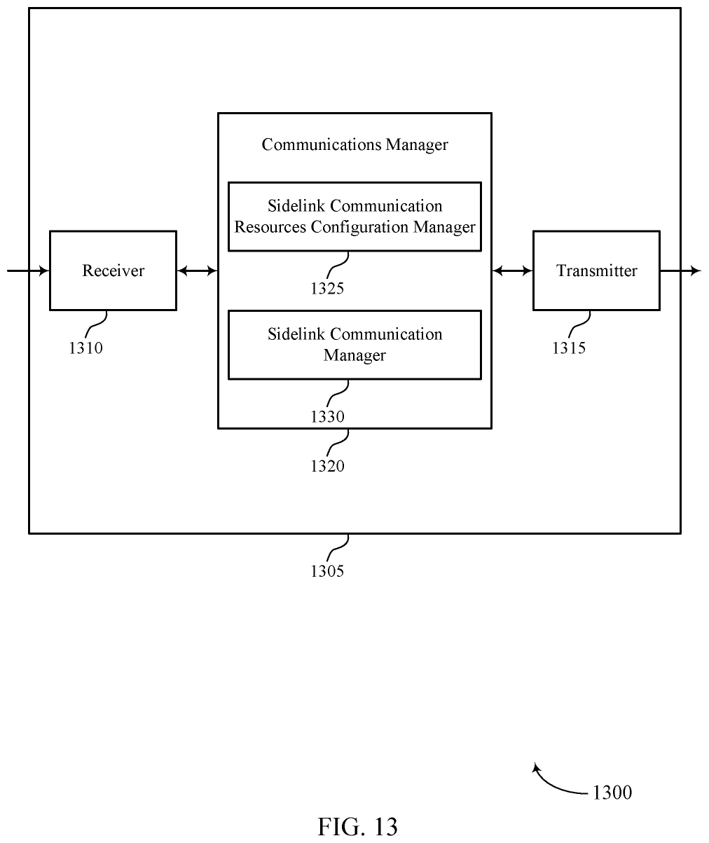

FIG. 13 shows a block diagram 1300 of a device 1305 that supports low power wake up radio in sidelink communications in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to low power wake up radio in sidelink communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to low power wake up radio in sidelink communications). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of low power wake up radio in sidelink communications as described herein. For example, the communications manager 1320 may include a sidelink communication resources configuration manager 1325 a sidelink communication manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first UE in accordance with examples as disclosed herein. The sidelink communication resources configuration manager 1325 may be configured as or otherwise support a means for receiving, from a network entity via a first radio of the first UE, control signaling indicating a configuration associated with a set of sidelink communication resources for receiving signaling via a wake up radio of the first UE while the first radio is in a sleep mode. The sidelink communication manager 1330 may be configured as or otherwise support a means for receiving, from a second UE via the wake up radio while the first radio is in the sleep mode, a signal via the set of sidelink communication resources in accordance with the configuration.

Additionally, or alternatively, the communications manager 1320 may support wireless communications at a second UE in accordance with examples as disclosed herein. The sidelink communication resources configuration manager 1325 may be configured as or otherwise support a means for receiving, from a network entity, control signaling indicating a configuration associated with a set of sidelink communication resources for transmitting signaling to a first UE while a first radio of the first UE is in a sleep mode. The sidelink communication manager 1330 may be configured as or otherwise support a means for transmitting, to the first UE, a signal via the set of sidelink communication resources in accordance with the configuration.

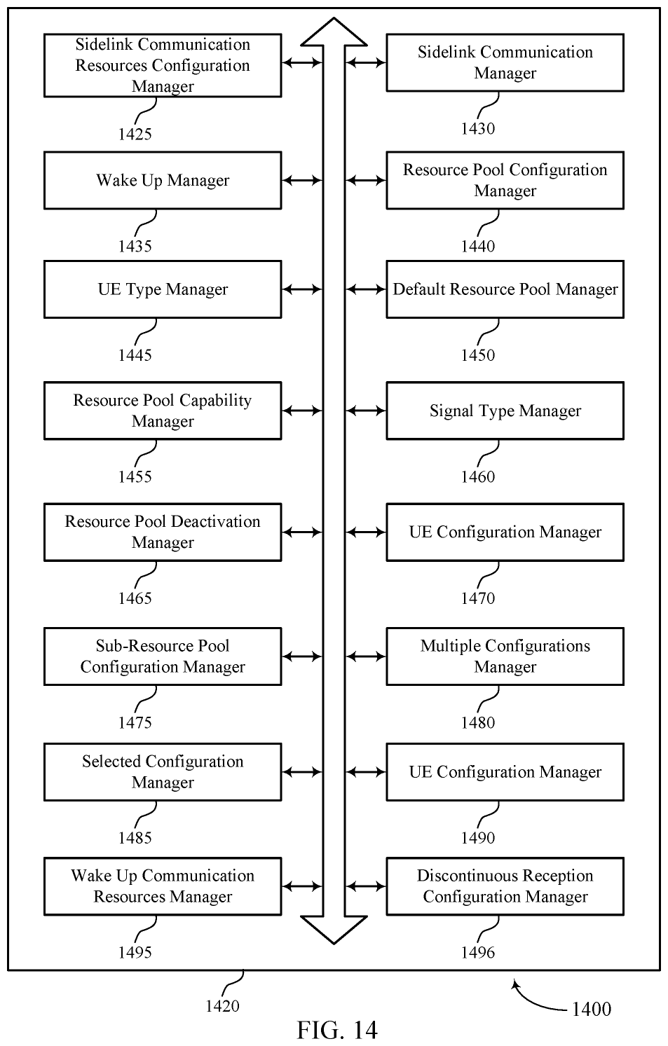

FIG. 14 shows a block diagram 1400 of a communications manager 1420 that supports low power wake up radio in sidelink communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of low power wake up radio in sidelink communications as described herein. For example, the communications manager 1420 may include a sidelink communication resources configuration manager 1425, a sidelink communication manager 1430, a wake up manager 1435, a resource pool configuration manager 1440, a UE type manager 1445, a default resource pool manager 1450, a resource pool capability manager 1455, a signal type manager 1460, a resource pool deactivation manager 1465, a UE configuration manager 1470, a sub-resource pool configuration manager 1475, a multiple configurations manager 1480, a selected configuration manager 1485, a UE configuration manager 1490, a wake up communication resources manager 1495, a DRX configuration manager 1496, or any combination thereof. Each of these components may communicate, directly or indirectly, with one another (e.g., via one or more buses).

The communications manager 1420 may support wireless communications at a first UE in accordance with examples as disclosed herein. The sidelink communication resources configuration manager 1425 may be configured as or otherwise support a means for receiving, from a network entity via a first radio of the first UE, control signaling indicating a configuration associated with a set of sidelink communication resources for receiving signaling via a wake up radio of the first UE while the first radio is in a sleep mode. The sidelink communication manager 1430 may be configured as or otherwise support a means for receiving, from a second UE via the wake up radio while the first radio is in the sleep mode, a signal via the set of sidelink communication resources in accordance with the configuration.

In some examples, the wake up manager 1435 may be configured as or otherwise support a means for communicating with one of the network entity or the second UE via the first radio based on receiving the signal via the wake up radio, where the signal includes a wake up signal.

In some examples, to support receiving the control signaling, the wake up communication resources manager 1495 may be configured as or otherwise support a means for receiving an indication of a first subset of the set of sidelink communication resources associated with wake up signals for communications with the network entity and a second subset of the set of sidelink communication resources associated with wake up signals for communications with other UEs, and where communicating with the one of the network entity or the second UE is based on the signal being received via the first subset or the second subset.

In some examples, a first DRX configuration associated with the first subset is associated with a first RRC state between the first UE and the network entity, a second DRX configuration associated with the first subset is associated with a second RRC state between the first UE and the network entity, a third DRX configuration associated with the first subset is associated with a third RRC state between the first UE and the network entity, a fourth DRX configuration associated with the second subset is associated with a fourth RRC state between the first UE and the second UE, a fifth DRX configuration associated with the second subset is associated with a fifth RRC state between the first UE and the second UE, and a sixth DRX configuration associated with the second subset is associated with a sixth RRC state between the first UE and the second UE.

In some examples, to support receiving the control signaling, the DRX configuration manager 1496 may be configured as or otherwise support a means for receiving an indication of one or more of a first DRX configuration associated with the first subset and a second DRX configuration associated with the second subset.

In some examples, to support receiving the control signaling, the resource pool configuration manager 1440 may be configured as or otherwise support a means for receiving an indication of the configuration per resource pool, where the set of sidelink communication resources includes a resource pool of a set of multiple resource pools associated with a BWP associated with sidelink communications for the first UE.

In some examples, the UE type manager 1445 may be configured as or otherwise support a means for transmitting, to the network entity, an indication of a UE type of the first UE, where the configuration is based on the UE type.

In some examples, the set of sidelink communication resources includes a resource pool. In some examples, the configuration includes a set of reference signal monitoring occasions for the resource pool, a set of synchronization signal monitoring occasions for the resource pool, a set of wake up signal monitoring occasions, or a combination thereof.

In some examples, the default resource pool manager 1450 may be configured as or otherwise support a means for receiving, from a third UE via the wake up radio while the first radio is in the sleep mode, a second signal via a default resource pool in accordance with a default configuration.

In some examples, the resource pool capability manager 1455 may be configured as or otherwise support a means for transmitting an indication of a quantity of resource pools the UE is capable of supporting via the wake up radio, where the configuration is based on the indication of the quantity of resource pools the UE is capable of supporting via the wake up radio.

In some examples, to support receiving the control signaling, the signal type manager 1460 may be configured as or otherwise support a means for receiving an indication of whether a reference signal, a synchronization signal, or a combination thereof is enabled for a resource pool corresponding to the set of sidelink communication resources.

In some examples, to support receiving the control signaling, the signal type manager 1460 may be configured as or otherwise support a means for receiving an indication that a synchronization signal is enabled for a resource pool corresponding to the set of sidelink communication resources, where the synchronization signal is located outside of the resource pool.

In some examples, to support receiving the control signaling, the resource pool deactivation manager 1465 may be configured as or otherwise support a means for receiving an indication of a set of multiple resource pools for sidelink communications, where the set of sidelink communication resources include a resource pool of the set of multiple resource pools, where the first UE deactivates monitoring of each resource pool of the set of multiple resource pools except for the resource pool while the first radio is in the sleep mode.

In some examples, to support receiving the control signaling, the UE configuration manager 1470 may be configured as or otherwise support a means for receiving an indication that the configuration is associated with the second UE.

In some examples, to support receiving the control signaling, the sub-resource pool configuration manager 1475 may be configured as or otherwise support a means for receiving an indication that the configuration is associated with a first sub-resource pool of a resource pool for sidelink communications, where the set of sidelink communication resources includes the first sub-resource pool, and where a guard band separates the first sub-resource pool from a second sub-resource pool of the resource pool.

In some examples, the multiple configurations manager 1480 may be configured as or otherwise support a means for receiving, with the control signaling, an indication of a set of multiple configurations associated with the set of sidelink communication resources, the set of multiple configurations including the configuration. In some examples, the selected configuration manager 1485 may be configured as or otherwise support a means for receiving, from the second UE, second control signaling indicating the configuration from the set of multiple configurations.

Additionally, or alternatively, the communications manager 1420 may support wireless communications at a second UE in accordance with examples as disclosed herein. In some examples, the sidelink communication resources configuration manager 1425 may be configured as or otherwise support a means for receiving, from a network entity, control signaling indicating a configuration associated with a set of sidelink communication resources for transmitting signaling to a first UE while a first radio of the first UE is in a sleep mode. In some examples, the sidelink communication manager 1430 may be configured as or otherwise support a means for transmitting, to the first UE, a signal via the set of sidelink communication resources in accordance with the configuration.

In some examples, the wake up manager 1435 may be configured as or otherwise support a means for communicating with the first UE based on transmitting the signal, where the signal includes a wake up signal.

In some examples, to support receiving the control signaling, the wake up communication resources manager 1495 may be configured as or otherwise support a means for receiving an indication of a first subset of the set of sidelink communication resources associated with wake up signals for communications with the network entity and a second subset of the set of sidelink communication resources associated with wake up signals for communications with other UEs, and where communicating with the first UE is based on the signal being transmitted via the second subset.

In some examples, to support receiving the control signaling, the DRX cycle manager 1496 may be configured as or otherwise support a means for receiving an indication of one or more of a first DRX configuration associated with the first subset and a second DRX configuration associated with the second subset.

In some examples, to support receiving the control signaling, the resource pool configuration manager 1440 may be configured as or otherwise support a means for receiving an indication of the configuration per resource pool, where the set of sidelink communication resources includes a resource pool of a set of multiple resource pools associated with a BWP associated with sidelink communications for the first UE.

In some examples, the set of sidelink communication resources includes a resource pool. In some examples, the configuration includes a set of reference signal monitoring occasions for the resource pool, a set of synchronization signal monitoring occasions for the resource pool, a set of wake up signal monitoring occasions, or a combination thereof.

In some examples, to support receiving the control signaling, the signal type manager 1460 may be configured as or otherwise support a means for receiving an indication of whether a reference signal, a synchronization signal, or a combination thereof is enabled for a resource pool corresponding to the set of sidelink communication resources.

In some examples, to support receiving the control signaling, the signal type manager 1460 may be configured as or otherwise support a means for receiving an indication that a synchronization signal is enabled for a resource pool corresponding to the set of sidelink communication resources, where the synchronization signal is located outside of the resource pool.

In some examples, to support receiving the control signaling, the resource pool deactivation manager 1465 may be configured as or otherwise support a means for receiving an indication of a set of multiple resource pools for sidelink communications, where the set of sidelink communication resources include a resource pool of the set of multiple resource pools.

In some examples, to support receiving the control signaling, the UE configuration manager 1490 may be configured as or otherwise support a means for receiving an indication that the configuration is associated with the first UE.

In some examples, to support receiving the control signaling, the sub-resource pool configuration manager 1475 may be configured as or otherwise support a means for receiving an indication that the configuration is associated with a first sub-resource pool of a resource pool for sidelink communications, where the set of sidelink communication resources includes the first sub-resource pool, and where a guard band separates the first sub-resource pool from a second sub-resource pool of the resource pool.

In some examples, the multiple configurations manager 1480 may be configured as or otherwise support a means for receiving, with the control signaling, an indication of a set of multiple configurations associated with the set of sidelink communication resources, the set of multiple configurations including the configuration. In some examples, the selected configuration manager 1485 may be configured as or otherwise support a means for transmitting, to the first UE, second control signaling indicating the configuration from the set of multiple configurations.

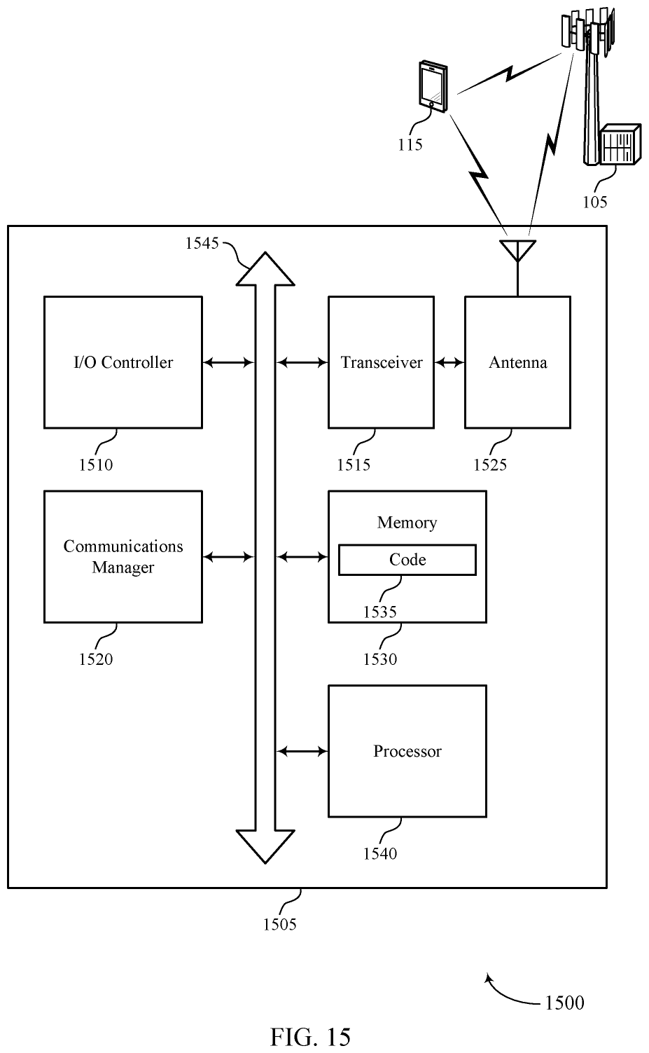

FIG. 15 shows a diagram of a system 1500 including a device 1505 that supports low power wake up radio in sidelink communications in accordance with one or more aspects of the present disclosure. The device 1505 may be an example of or include the components of a device 1205, a device 1305, or a UE 115 as described herein. The device 1505 may communicate (e.g., wirelessly) with one or more network entities 105, one or more UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, a memory 1530, code 1535, and a processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of a processor, such as the processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include random access memory (RAM) and read-only memory (ROM). The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a basic I/O system (BIOS) which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting low power wake up radio in sidelink communications). For example, the device 1505 or a component of the device 1505 may include a processor 1540 and memory 1530 coupled with or to the processor 1540, the processor 1540 and memory 1530 configured to perform various functions described herein.

The communications manager 1520 may support wireless communications at a first UE in accordance with examples as disclosed herein. For example, the communications manager 1520 may be configured as or otherwise support a means for receiving, from a network entity via a first radio of the first UE, control signaling indicating a configuration associated with a set of sidelink communication resources for receiving signaling via a wake up radio of the first UE while the first radio is in a sleep mode. The communications manager 1520 may be configured as or otherwise support a means for receiving, from a second UE via the wake up radio while the first radio is in the sleep mode, a signal via the set of sidelink communication resources in accordance with the configuration.

Additionally, or alternatively, the communications manager 1520 may support wireless communications at a second UE in accordance with examples as disclosed herein. For example, the communications manager 1520 may be configured as or otherwise support a means for receiving, from a network entity, control signaling indicating a configuration associated with a set of sidelink communication resources for transmitting signaling to a first UE while a first radio of the first UE is in a sleep mode. The communications manager 1520 may be configured as or otherwise support a means for transmitting, to the first UE, a signal via the set of sidelink communication resources in accordance with the configuration.

By including or configuring the communications manager 1520 in accordance with examples as described herein, the device 1505 may support techniques for reduced latency, reduced power consumption, more efficient utilization of communication resources, improved coordination between devices, longer battery life, improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of low power wake up radio in sidelink communications as described herein, or the processor 1540 and the memory 1530 may be otherwise configured to perform or support such operations.

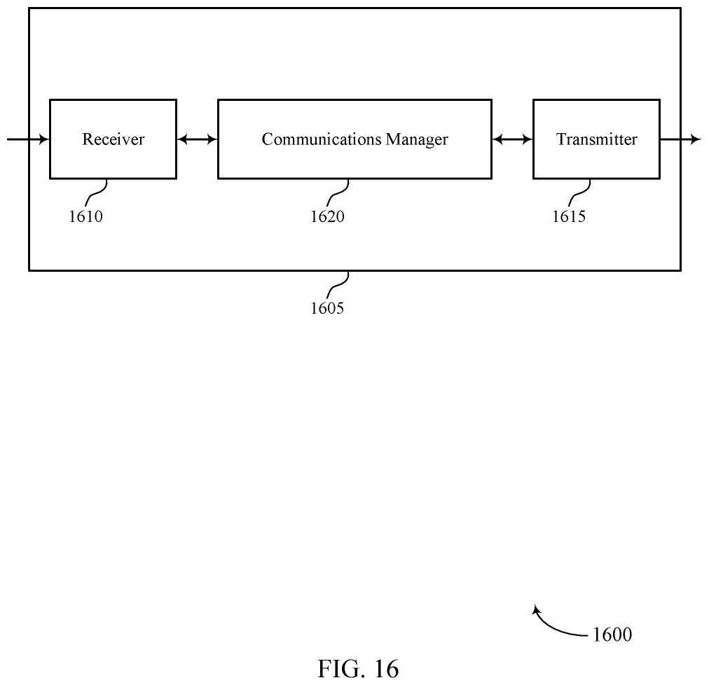

FIG. 16 shows a block diagram 1600 of a device 1605 that supports low power wake up radio in sidelink communications in accordance with one or more aspects of the present disclosure. The device 1605 may be an example of aspects of a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations thereof or various components thereof may be examples of means for performing various aspects of low power wake up radio in sidelink communications as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1620, the receiver 1610, the transmitter 1615, or various combinations or components thereof may be implemented in code (e.g., as communications management software or firmware) executed by a processor. If implemented in code executed by a processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a network entity in accordance with examples as disclosed herein. For example, the communications manager 1620 may be configured as or otherwise support a means for receiving, from a first UE, an indication of a UE type of the first UE. The communications manager 1620 may be configured as or otherwise support a means for transmitting, to the first UE, control signaling indicating a configuration associated with a set of sidelink communication resources for receiving signaling from a second UE while a first radio of the first UE is in a sleep mode.

By including or configuring the communications manager 1620 in accordance with examples as described herein, the device 1605 (e.g., a processor controlling or otherwise coupled with the receiver 1610, the transmitter 1615, the communications manager 1620, or a combination thereof) may support techniques for power consumption and more efficient utilization of communication resources.

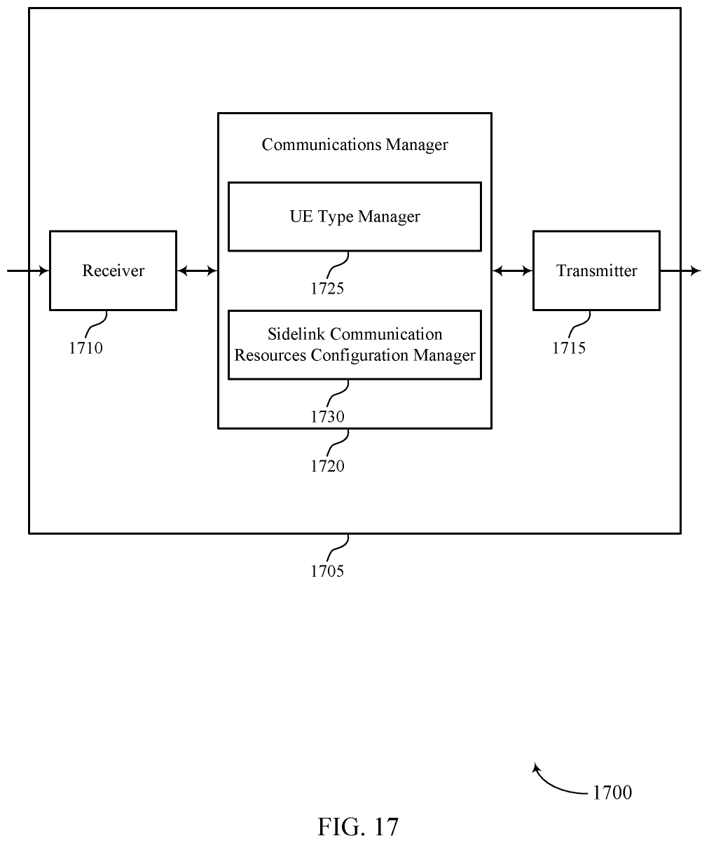

FIG. 17 shows a block diagram 1700 of a device 1705 that supports low power wake up radio in sidelink communications in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of low power wake up radio in sidelink communications as described herein. For example, the communications manager 1720 may include a UE type manager 1725 a sidelink communication resources configuration manager 1730, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications at a network entity in accordance with examples as disclosed herein. The UE type manager 1725 may be configured as or otherwise support a means for receiving, from a first UE, an indication of a UE type of the first UE. The sidelink communication resources configuration manager 1730 may be configured as or otherwise support a means for transmitting, to the first UE, control signaling indicating a configuration associated with a set of sidelink communication resources for receiving signaling from a second UE while a first radio of the first UE is in a sleep mode.

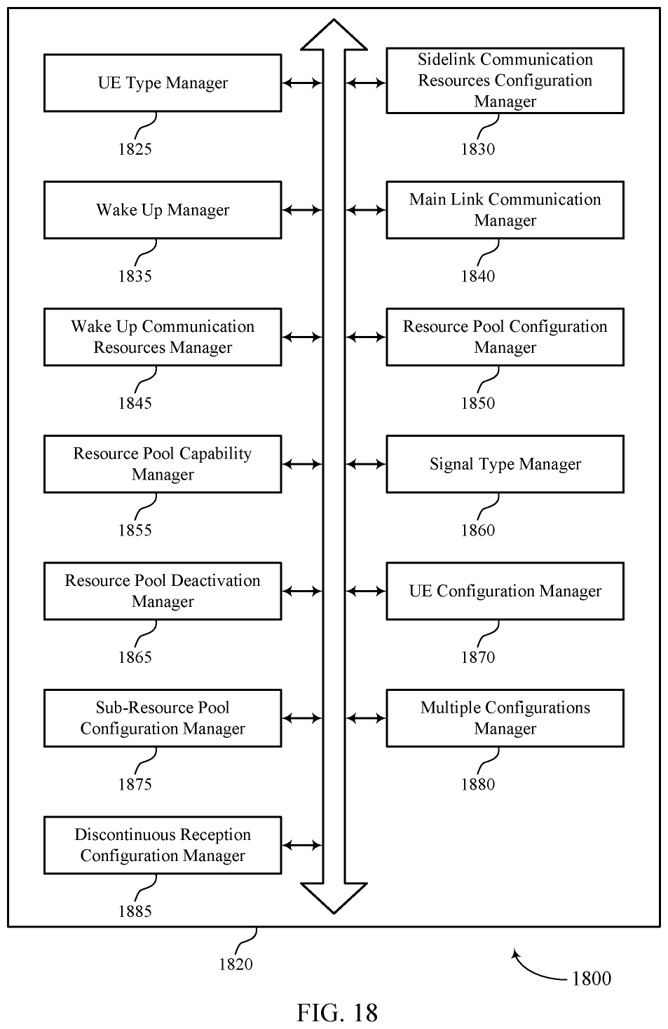

FIG. 18 shows a block diagram 1800 of a communications manager 1820 that supports low power wake up radio in sidelink communications in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of low power wake up radio in sidelink communications as described herein. For example, the communications manager 1820 may include a UE type manager 1825, a sidelink communication resources configuration manager 1830, a wake up manager 1835, a main link communication manager 1840, a wake up communication resources manager 1845, a resource pool configuration manager 1850, a resource pool capability manager 1855, a signal type manager 1860, a resource pool deactivation manager 1865, a UE configuration manager 1870, a sub-resource pool configuration manager 1875, a multiple configurations manager 1880, a DRX configuration manager 1885, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communications at a network entity in accordance with examples as disclosed herein. The UE type manager 1825 may be configured as or otherwise support a means for receiving, from a first UE, an indication of a UE type of the first UE. The sidelink communication resources configuration manager 1830 may be configured as or otherwise support a means for transmitting, to the first UE, control signaling indicating a configuration associated with a set of sidelink communication resources for receiving signaling from a second UE while a first radio of the first UE is in a sleep mode.

In some examples, the wake up manager 1835 may be configured as or otherwise support a means for transmitting, to the second UE, second control signaling indicating to transmit a wake up signal to the first UE in accordance with the configuration. In some examples, the main link communication manager 1840 may be configured as or otherwise support a means for communicating with the first UE based on transmitting the second control signaling.

In some examples, to support transmitting the control signaling, the wake up communication resources manager 1845 may be configured as or otherwise support a means for transmitting an indication of a first subset of the set of sidelink communication resources associated with wake up signals for communications with the network entity and a second subset of the set of sidelink communication resources associated with wake up signals for communications with other UEs.

In some examples, to support transmitting the control signaling, the DRX configuration manager 1885 may be configured as or otherwise support a means for transmitting an indication of one or more of a first DRX configuration associated with the first subset and a second DRX configuration associated with the second subset.

In some examples, to support transmitting the control signaling, the resource pool configuration manager 1850 may be configured as or otherwise support a means for transmitting an indication of the configuration per resource pool, where the set of sidelink communication resources includes a resource pool of a set of multiple resource pools associated with a BWP associated with sidelink communications for the first UE.

In some examples, the set of sidelink communication resources includes a resource pool. In some examples, the configuration includes a set of reference signal monitoring occasions for the resource pool, a set of synchronization signal monitoring occasions for the resource pool, a set of wake up signal monitoring occasions, or a combination thereof.

In some examples, the resource pool capability manager 1855 may be configured as or otherwise support a means for receiving, from the first UE, an indication of a quantity of resource pools the UE is capable of supporting in the sleep mode, where the configuration is based on the indication of the quantity of resource pools the UE is capable of supporting in the sleep mode.

In some examples, to support transmitting the control signaling, the signal type manager 1860 may be configured as or otherwise support a means for transmitting an indication of whether a reference signal, a synchronization signal, or a combination thereof is enabled for a resource pool corresponding to the set of sidelink communication resources.

In some examples, to support transmitting the control signaling, the signal type manager 1860 may be configured as or otherwise support a means for transmitting an indication that a synchronization signal is enabled for a resource pool corresponding to the set of sidelink communication resources, where the synchronization signal is located outside of the resource pool.

In some examples, to support transmitting the control signaling, the resource pool deactivation manager 1865 may be configured as or otherwise support a means for transmitting an indication of a set of multiple resource pools for sidelink communications, where the set of sidelink communication resources include a resource pool of the set of multiple resource pools.

In some examples, to support transmitting the control signaling, the UE configuration manager 1870 may be configured as or otherwise support a means for transmitting an indication that the configuration is associated with the second UE.

In some examples, to support transmitting the control signaling, the sub-resource pool configuration manager 1875 may be configured as or otherwise support a means for transmitting an indication that the configuration is associated with a first sub-resource pool of a resource pool for sidelink communications, where the set of sidelink communication resources includes the first sub-resource pool, and where a guard band separates the first sub-resource pool from a second sub-resource pool of the resource pool.

In some examples, to support transmitting the control signaling, the multiple configurations manager 1880 may be configured as or otherwise support a means for transmitting an indication of a set of multiple configurations associated with the set of sidelink communication resources, the set of multiple configurations including the configuration.

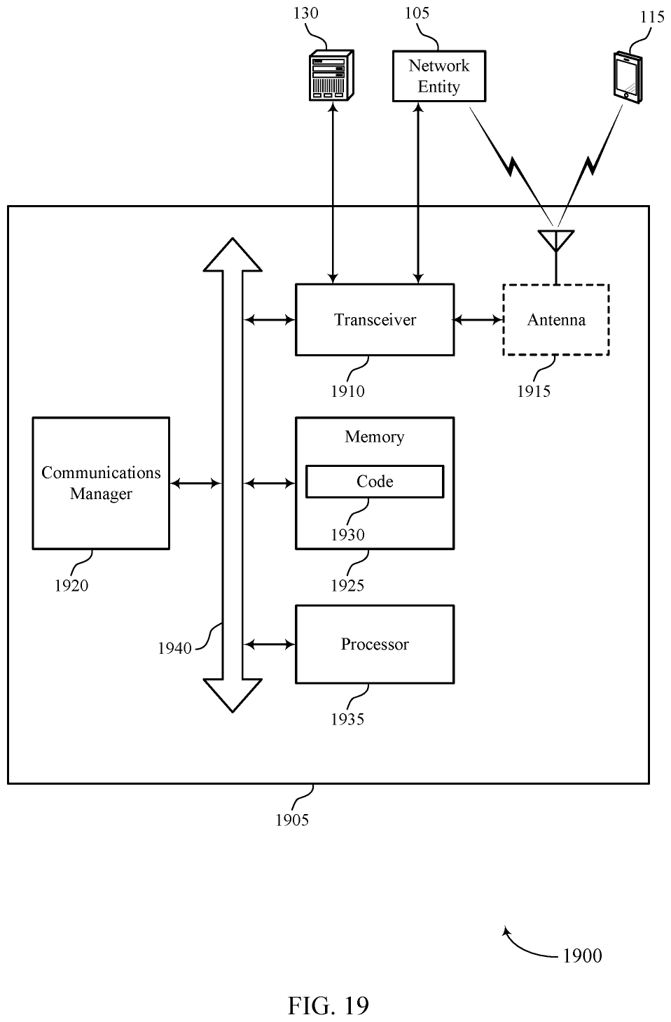

FIG. 19 shows a diagram of a system 1900 including a device 1905 that supports low power wake up radio in sidelink communications in accordance with one or more aspects of the present disclosure. The device 1905 may be an example of or include the components of a device 1605, a device 1705, or a network entity 105 as described herein. The device 1905 may communicate with one or more network entities 105, one or more UEs 115, or any combination thereof, which may include communications over one or more wired interfaces, over one or more wireless interfaces, or any combination thereof. The device 1905 may include components that support outputting and obtaining communications, such as a communications manager 1920, a transceiver 1910, an antenna 1915, a memory 1925, code 1930, and a processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or memory components (for example, the processor 1935, or the memory 1925, or both), may be included in a chip or chip assembly that is installed in the device 1905. In some examples, the transceiver may be operable to support communications via one or more communications links (e.g., a communication link 125, a backhaul communication link 120, a midhaul communication link 162, a fronthaul communication link 168).

The memory 1925 may include RAM and ROM. The memory 1925 may store computer-readable, computer-executable code 1930 including instructions that, when executed by the processor 1935, cause the device 1905 to perform various functions described herein. The code 1930 may be stored in a non-transitory computer-readable medium such as system memory or another type of memory. In some cases, the code 1930 may not be directly executable by the processor 1935 but may cause a computer (e.g., when compiled and executed) to perform functions described herein. In some cases, the memory 1925 may contain, among other things, a BIOS which may control basic hardware or software operation such as the interaction with peripheral components or devices.

The processor 1935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1935 may be configured to operate a memory array using a memory controller. In some other cases, a memory controller may be integrated into the processor 1935. The processor 1935 may be configured to execute computer-readable instructions stored in a memory (e.g., the memory 1925) to cause the device 1905 to perform various functions (e.g., functions or tasks supporting low power wake up radio in sidelink communications). For example, the device 1905 or a component of the device 1905 may include a processor 1935 and memory 1925 coupled with the processor 1935, the processor 1935 and memory 1925 configured to perform various functions described herein. The processor 1935 may be an example of a cloud-computing platform (e.g., one or more physical nodes and supporting software such as operating systems, virtual machines, or container instances) that may host the functions (e.g., by executing code 1930) to perform the functions of the device 1905. The processor 1935 may be any one or more suitable processors capable of executing scripts or instructions of one or more software programs stored in the device 1905 (such as within the memory 1925). In some implementations, the processor 1935 may be a component of a processing system. A processing system may generally refer to a system or series of machines or components that receives inputs and processes the inputs to produce a set of outputs (which may be passed to other systems or components of, for example, the device 1905). For example, a processing system of the device 1905 may refer to a system including the various other components or subcomponents of the device 1905, such as the processor 1935, or the transceiver 1910, or the communications manager 1920, or other components or combinations of components of the device 1905. The processing system of the device 1905 may interface with other components of the device 1905 and may process information received from other components (such as inputs or signals) or output information to other components. For example, a chip or modem of the device 1905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1905 may transmit information output from the chip or modem. Additionally, or alternatively, in some implementations, the one or more interfaces may refer to an interface between the processing system of the chip or modem and a receiver, such that the device 1905 may obtain information or signal inputs, and the information may be passed to the processing system. A person having ordinary skill in the art will readily recognize that a first interface also may obtain information or signal inputs, and a second interface also may output information or signal outputs.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the memory 1925, the code 1930, and the processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with other network entities 105 and may include a controller or scheduler for controlling communications with UEs 115 in cooperation with other network entities 105. In some examples, the communications manager 1920 may support an X2 interface within an LTE/LTE-A wireless communications network technology to provide communication between network entities 105.

The communications manager 1920 may support wireless communications at a network entity in accordance with examples as disclosed herein. For example, the communications manager 1920 may be configured as or otherwise support a means for receiving, from a first UE, an indication of a UE type of the first UE. The communications manager 1920 may be configured as or otherwise support a means for transmitting, to the first UE, control signaling indicating a configuration associated with a set of sidelink communication resources for receiving signaling from a second UE while a first radio of the first UE is in a sleep mode.

By including or configuring the communications manager 1920 in accordance with examples as described herein, the device 1905 may support techniques for improved communication reliability, reduced latency, improved user experience related to reduced processing, reduced power consumption, more efficient utilization of communication resources, improved coordination between devices and longer battery life.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, the processor 1935, the memory 1925, the code 1930, or any combination thereof. For example, the code 1930 may include instructions executable by the processor 1935 to cause the device 1905 to perform various aspects of low power wake up radio in sidelink communications as described herein, or the processor 1935 and the memory 1925 may be otherwise configured to perform or support such operations.

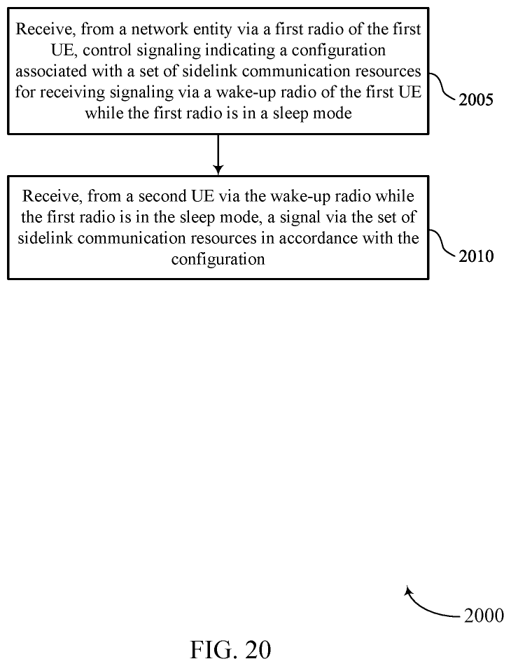

FIG. 20 shows a flowchart illustrating a method 2000 that supports low power wake up radio in sidelink communications in accordance with one or more aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2005, the method may include receiving, from a network entity via a first radio of the first UE, control signaling indicating a configuration associated with a set of sidelink communication resources for receiving signaling via a wake up radio of the first UE while the first radio is in a sleep mode. The operations of 2005 may be performed in accordance with examples as disclosed herein. In some examples, aspects of the operations of 2005 may be performed by a sidelink communication resources configuration manager 1425 as described with reference to FIG. 14.

At 2010, the method may include receiving, from a second UE via the wake up radio while the first radio is in the sleep mode, a signal via the set of sidelink communication resources in accordance with the configuration. The operations of 2010 may be performed in accordance with examples as disclosed herein. In some examples, aspects of the operations of 2010 may be performed by a sidelink communication manager 1430 as described with reference to FIG. 14.

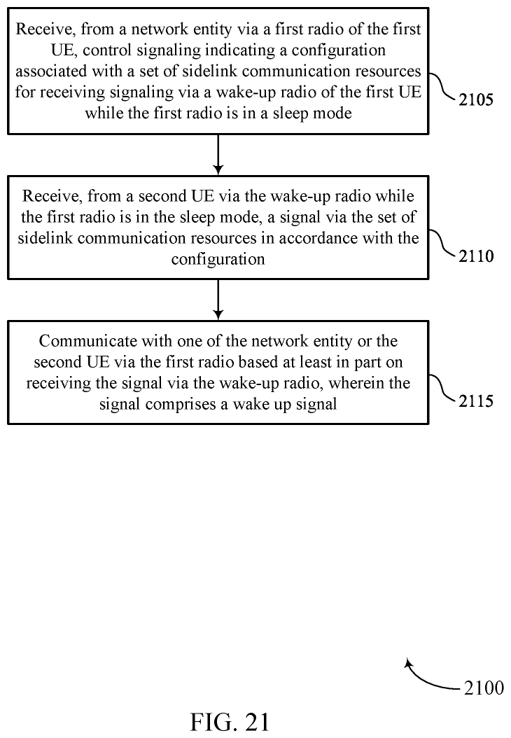

FIG. 21 shows a flowchart illustrating a method 2100 that supports low power wake up radio in sidelink communications in accordance with one or more aspects of the present disclosure. The operations of the method 2100 may be implemented by a UE or its components as described herein. For example, the operations of the method 2100 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2105, the method may include receiving, from a network entity via a first radio of the first UE, control signaling indicating a configuration associated with a set of sidelink communication resources for receiving signaling via a wake up radio of the first UE while the first radio is in a sleep mode. The operations of 2105 may be performed in accordance with examples as disclosed herein. In some examples, aspects of the operations of 2105 may be performed by a sidelink communication resources configuration manager 1425 as described with reference to FIG. 14.

At 2110, the method may include receiving, from a second UE via the wake up radio while the first radio is in the sleep mode, a signal via the set of sidelink communication resources in accordance with the configuration. The operations of 2110 may be performed in accordance with examples as disclosed herein. In some examples, aspects of the operations of 2110 may be performed by a sidelink communication manager 1430 as described with reference to FIG. 14.

At 2115, the method may include communicating with one of the network entity or the second UE via the first radio based on receiving the signal via the wake up radio, where the signal includes a wake up signal. The operations of 2115 may be performed in accordance with examples as disclosed herein. In some examples, aspects of the operations of 2115 may be performed by a wake up manager 1435 as described with reference to FIG. 14.

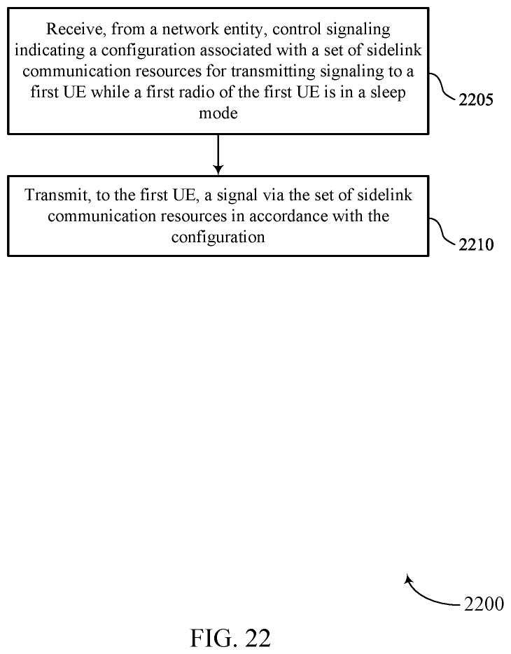

FIG. 22 shows a flowchart illustrating a method 2200 that supports low power wake up radio in sidelink communications in accordance with one or more aspects of the present disclosure. The operations of the method 2200 may be implemented by a UE or its components as described herein. For example, the operations of the method 2200 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2205, the method may include receiving, from a network entity, control signaling indicating a configuration associated with a set of sidelink communication resources for transmitting signaling to a first UE while a first radio of the first UE is in a sleep mode. The operations of 2205 may be performed in accordance with examples as disclosed herein. In some examples, aspects of the operations of 2205 may be performed by a sidelink communication resources configuration manager 1425 as described with reference to FIG. 14.

At 2210, the method may include transmitting, to the first UE, a signal via the set of sidelink communication resources in accordance with the configuration. The operations of 2210 may be performed in accordance with examples as disclosed herein. In some examples, aspects of the operations of 2210 may be performed by a sidelink communication manager 1430 as described with reference to FIG. 14.

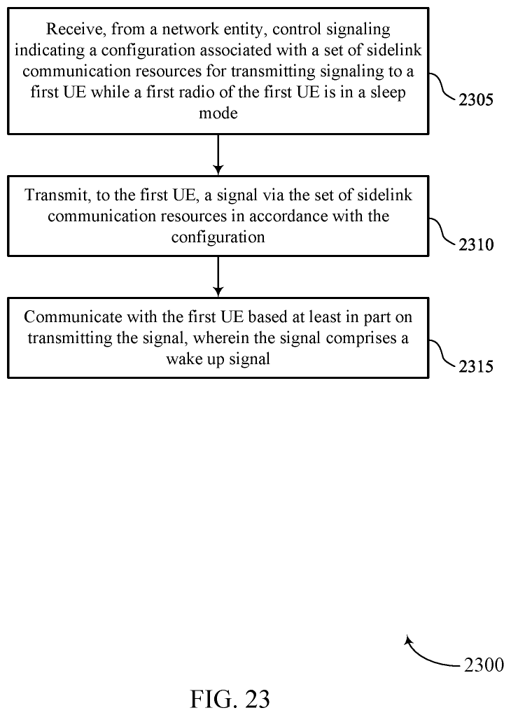

FIG. 23 shows a flowchart illustrating a method 2300 that supports low power wake up radio in sidelink communications in accordance with one or more aspects of the present disclosure. The operations of the method 2300 may be implemented by a UE or its components as described herein. For example, the operations of the method 2300 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2305, the method may include receiving, from a network entity, control signaling indicating a configuration associated with a set of sidelink communication resources for transmitting signaling to a first UE while a first radio of the first UE is in a sleep mode. The operations of 2305 may be performed in accordance with examples as disclosed herein. In some examples, aspects of the operations of 2305 may be performed by a sidelink communication resources configuration manager 1425 as described with reference to FIG. 14.

At 2310, the method may include transmitting, to the first UE, a signal via the set of sidelink communication resources in accordance with the configuration. The operations of 2310 may be performed in accordance with examples as disclosed herein. In some examples, aspects of the operations of 2310 may be performed by a sidelink communication manager 1430 as described with reference to FIG. 14.

At 2315, the method may include communicating with the first UE based on transmitting the signal, where the signal includes a wake up signal. The operations of 2315 may be performed in accordance with examples as disclosed herein. In some examples, aspects of the operations of 2315 may be performed by a wake up manager 1435 as described with reference to FIG. 14.

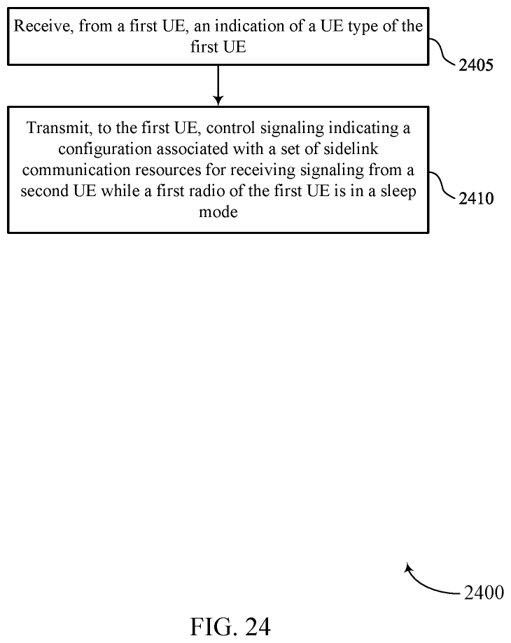

FIG. 24 shows a flowchart illustrating a method 2400 that supports low power wake up radio in sidelink communications in accordance with one or more aspects of the present disclosure. The operations of the method 2400 may be implemented by a network entity or its components as described herein. For example, the operations of the method 2400 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2405, the method may include receiving, from a first UE, an indication of a UE type of the first UE. The operations of 2405 may be performed in accordance with examples as disclosed herein. In some examples, aspects of the operations of 2405 may be performed by a UE type manager 1825 as described with reference to FIG. 18.

At 2410, the method may include transmitting, to the first UE, control signaling indicating a configuration associated with a set of sidelink communication resources for receiving signaling from a second UE while a first radio of the first UE is in a sleep mode. The operations of 2410 may be performed in accordance with examples as disclosed herein. In some examples, aspects of the operations of 2410 may be performed by a sidelink communication resources configuration manager 1830 as described with reference to FIG. 18.

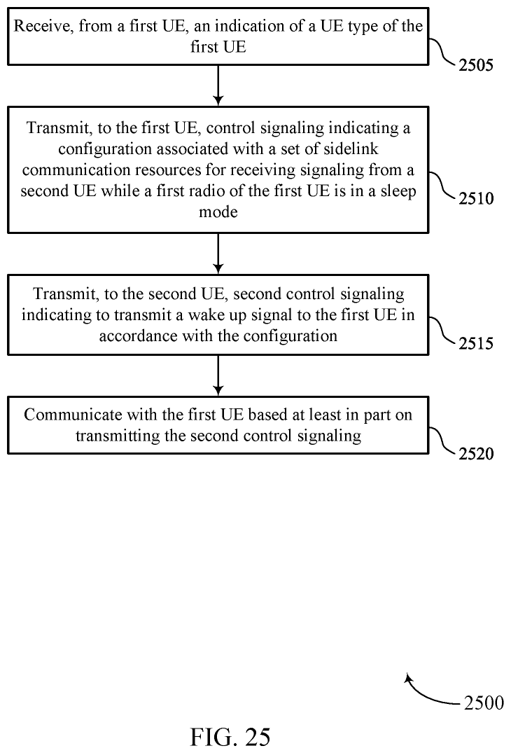

FIG. 25 shows a flowchart illustrating a method 2500 that supports low power wake up radio in sidelink communications in accordance with one or more aspects of the present disclosure. The operations of the method 2500 may be implemented by a network entity or its components as described herein. For example, the operations of the method 2500 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2505, the method may include receiving, from a first UE, an indication of a UE type of the first UE. The operations of 2505 may be performed in accordance with examples as disclosed herein. In some examples, aspects of the operations of 2505 may be performed by a UE type manager 1825 as described with reference to FIG. 18.

At 2510, the method may include transmitting, to the first UE, control signaling indicating a configuration associated with a set of sidelink communication resources for receiving signaling from a second UE while a first radio of the first UE is in a sleep mode. The operations of 2510 may be performed in accordance with examples as disclosed herein. In some examples, aspects of the operations of 2510 may be performed by a sidelink communication resources configuration manager 1830 as described with reference to FIG. 18.

At 2515, the method may include transmitting, to the second UE, second control signaling indicating to transmit a wake up signal to the first UE in accordance with the configuration. The operations of 2515 may be performed in accordance with examples as disclosed herein. In some examples, aspects of the operations of 2515 may be performed by a wake up manager 1835 as described with reference to FIG. 18.

At 2520, the method may include communicating with the first UE based on transmitting the second control signaling. The operations of 2520 may be performed in accordance with examples as disclosed herein. In some examples, aspects of the operations of 2520 may be performed by a main link communication manager 1840 as described with reference to FIG. 18.

The following provides an overview of aspects of the present disclosure:
Aspect 1: A method for wireless communications at a first UE, comprising: receiving, from a network entity via a first radio of the first UE, control signaling indicating a configuration associated with a set of sidelink communication resources for receiving signaling via a wake up radio of the first UE while the first radio is in a sleep mode; and receiving, from a second UE via the wake up radio while the first radio is in the sleep mode, a signal via the set of sidelink communication resources in accordance with the configuration.
Aspect 2: The method of aspect 1, further comprising: communicating with one of the network entity or the second UE via the first radio based at least in part on receiving the signal via the wake up radio, wherein the signal comprises a wake up signal.
Aspect 3: The method of aspect 2, wherein receiving the control signaling comprises: receiving an indication of a first subset of the set of sidelink communication resources associated with wake up signals for communications with the network entity and a second subset of the set of sidelink communication resources associated with wake up signals for communications with other UEs, and wherein communicating with the one of the network entity or the second UE is based at least in part on the signal being received via the first subset or the second subset.
Aspect 4: The method of aspect 3, wherein receiving the control signaling comprises: receiving an indication of one or more of a first DRX configuration associated with the first subset and a second DRX configuration associated with the second subset.
Aspect 5: The method of any of aspects 3 through 4, wherein a first DRX configuration associated with the first subset is associated with a first radio resource control state between the first UE and the network entity, a second DRX configuration associated with the first subset is associated with a second radio resource control state between the first UE and the network entity, a third DRX configuration associated with the first subset is associated with a third radio resource control state between the first UE and the network entity, a fourth DRX configuration associated with the second subset is associated with a fourth radio resource control state between the first UE and the second UE, a fifth DRX configuration associated with the second subset is associated with a fifth radio resource control state between the first UE and the second UE, and a sixth DRX configuration associated with the second subset is associated with a sixth radio resource control state between the first UE and the second UE.
Aspect 6: The method of any of aspects 1 through 5, wherein receiving the control signaling comprises: receiving an indication of the configuration per resource pool, wherein the set of sidelink communication resources comprises a resource pool of a plurality of resource pools associated with a BWP associated with sidelink communications for the first UE.
Aspect 7: The method of any of aspects 1 through 6, further comprising: transmitting, to the network entity, an indication of a UE type of the first UE, wherein the configuration is based on the UE type.
Aspect 8: The method of any of aspects 1 through 7, wherein the set of sidelink communication resources comprises a resource pool, and the configuration comprises a set of reference signal monitoring occasions for the resource pool, a set of synchronization signal monitoring occasions for the resource pool, a set of wake up signal monitoring occasions, or a combination thereof.
Aspect 9: The method of any of aspects 1 through 8, further comprising: receiving, from a third UE via the wake up radio while the first radio is in the sleep mode, a second signal via a default resource pool in accordance with a default configuration.
Aspect 10: The method of any of aspects 1 through 9, further comprising: transmitting an indication of a quantity of resource pools the UE is capable of supporting via the wake up radio, wherein the configuration is based at least in part on the indication of the quantity of resource pools the UE is capable of supporting via the wake up radio.
Aspect 11: The method of any of aspects 1 through 10, The method of any of aspects 1 through 10, wherein receiving the control signaling comprises: receiving an indication of whether a reference signal, a synchronization signal, or a combination thereof is enabled for a resource pool corresponding to the set of sidelink communication resources.
Aspect 12: The method of any of aspects 1 through 11, wherein receiving the control signaling comprises: receiving an indication that a synchronization signal is enabled for a resource pool corresponding to the set of sidelink communication resources, wherein the synchronization signal is located outside of the resource pool.
Aspect 13: The method of any of aspects 1 through 12, wherein receiving the control signaling comprises: receiving an indication of a plurality of resource pools for sidelink communications, wherein the set of sidelink communication resources comprise a resource pool of the plurality of resource pools, wherein the first UE deactivates monitoring of each resource pool of the plurality of resource pools except for the resource pool while the first radio is in the sleep mode.
Aspect 14: The method of any of aspects 1 through 13, wherein receiving the control signaling comprises: receiving an indication that the configuration is associated with the second UE.
Aspect 15: The method of any of aspects 1 through 14, wherein receiving the control signaling comprises: receiving an indication that the configuration is associated with a first sub-resource pool of a resource pool for sidelink communications, wherein the set of sidelink communication resources comprises the first sub-resource pool, and

wherein a guard band separates the first sub-resource pool from a second sub-resource pool of the resource pool.
Aspect 16: The method of any of aspects 1 through 15, further comprising: receiving, with the control signaling, an indication of a plurality of configurations associated with the set of sidelink communication resources, the plurality of configurations comprising the configuration; and receiving, from the second UE, second control signaling indicating the configuration from the plurality of configurations.
Aspect 17: A method for wireless communications at a second UE, comprising: receiving, from a network entity, control signaling indicating a configuration associated with a set of sidelink communication resources for transmitting signaling to a first UE while a first radio of the first UE is in a sleep mode; and transmitting, to the first UE, a signal via the set of sidelink communication resources in accordance with the configuration.
Aspect 18: The method of aspect 17, further comprising: communicating with the first UE based at least in part on transmitting the signal, wherein the signal comprises a wake up signal.
Aspect 19: The method of aspect 18, wherein receiving the control signaling comprises: receiving an indication of a first subset of the set of sidelink communication resources associated with wake up signals for communications with the network entity and a second subset of the set of sidelink communication resources associated with wake up signals for communications with other UEs, and wherein communicating with the first UE is based at least in part on the signal being transmitted via the second subset.
Aspect 20: The method of aspect 19, wherein receiving the control signaling comprises: receiving an indication of one or more of a first DRX configuration associated with the first subset and a second DRX configuration associated with the second subset.
Aspect 21: The method of any of aspects 17 through 20, wherein receiving the control signaling comprises: receiving an indication of the configuration per resource pool, wherein the set of sidelink communication resources comprises a resource pool of a plurality of resource pools associated with a BWP associated with sidelink communications for the first UE.
Aspect 22: The method of any of aspects 17 through 21, wherein the set of sidelink communication resources comprises a resource pool, and the configuration comprises a set of reference signal monitoring occasions for the resource pool, a set of synchronization signal monitoring occasions for the resource pool, a set of wake up signal monitoring occasions, or a combination thereof
Aspect 23: The method of any of aspects 17 through 22, wherein receiving the control signaling comprises: receiving an indication of whether a reference signal, a synchronization signal, or a combination thereof is enabled for a resource pool corresponding to the set of sidelink communication resources.
Aspect 24: The method of any of aspects 17 through 23, wherein receiving the control signaling comprises: receiving an indication that a synchronization signal is enabled for a resource pool corresponding to the set of sidelink communication resources, wherein the synchronization signal is located outside of the resource pool.
Aspect 25: The method of any of aspects 17 through 24, wherein receiving the control signaling comprises: receiving an indication of a plurality of resource pools for sidelink communications, wherein the set of sidelink communication resources comprise a resource pool of the plurality of resource pools.
Aspect 26: The method of any of aspects 17 through 25, wherein receiving the control signaling comprises: receiving an indication that the configuration is associated with the first UE.
Aspect 27: The method of any of aspects 17 through 26, wherein receiving the control signaling comprises: receiving an indication that the configuration is associated with a first sub-resource pool of a resource pool for sidelink communications, wherein the set of sidelink communication resources comprises the first sub-resource pool, and wherein a guard band separates the first sub-resource pool from a second sub-resource pool of the resource pool.
Aspect 28: The method of any of aspects 17 through 27, further comprising: receiving, with the control signaling, an indication of a plurality of configurations associated with the set of sidelink communication resources, the plurality of configurations comprising the configuration; and transmitting, to the first UE, second control signaling indicating the configuration from the plurality of configurations.
Aspect 29: A method for wireless communications at a network entity, comprising: receiving, from a first UE, an indication of a UE type of the first UE; and transmitting, to the first UE, control signaling indicating a configuration associated with a set of sidelink communication resources for receiving signaling from a second UE while a first radio of the first UE is in a sleep mode.
Aspect 30: The method of aspect 29, further comprising: transmitting, to the second UE, second control signaling indicating to transmit a wake up signal to the first UE in accordance with the configuration; and communicating with the first UE based at least in part on transmitting the second control signaling.
Aspect 31: The method of any of aspects 29 through 30, wherein transmitting the control signaling comprises: transmitting an indication of a first subset of the set of sidelink communication resources associated with wake up signals for communications with the network entity and a second subset of the set of sidelink communication resources associated with wake up signals for communications with other UEs.
Aspect 32: The method of aspect 31, wherein transmitting the control signaling comprises: transmitting an indication of one or more of a first DRX configuration associated with the first subset and a second DRX configuration associated with the second subset.
Aspect 33: The method of any of aspects 29 through 32, wherein transmitting the control signaling comprises: transmitting an indication of the configuration per resource pool, wherein the set of sidelink communication resources comprises a resource pool of a plurality of resource pools associated with a BWP associated with sidelink communications for the first UE.
Aspect 34: The method of any of aspects 29 through 33, wherein the set of sidelink communication resources comprises a resource pool, and the configuration comprises a set of reference signal monitoring occasions for the resource pool, a set of synchronization signal monitoring occasions for the resource pool, a set of wake up signal monitoring occasions, or a combination thereof
Aspect 35: The method of any of aspects 29 through 34, further comprising: receiving, from the first UE, an indication of a quantity of resource pools the UE is capable of supporting in the sleep mode, wherein the configuration is based at least in part on the indication of the quantity of resource pools the UE is capable of supporting in the sleep mode.
Aspect 36: The method of any of aspects 29 through 35, wherein transmitting the control signaling comprises: transmitting an indication of whether a reference signal, a synchronization signal, or a combination thereof is enabled for a resource pool corresponding to the set of sidelink communication resources.
Aspect 37: The method of any of aspects 29 through 36, wherein transmitting the control signaling comprises: transmitting an indication that a synchronization signal is enabled for a resource pool corresponding to the set of sidelink communication resources, wherein the synchronization signal is located outside of the resource pool.
Aspect 38: The method of any of aspects 29 through 37, wherein transmitting the control signaling comprises: transmitting an indication of a plurality of resource pools for sidelink communications, wherein the set of sidelink communication resources comprise a resource pool of the plurality of resource pools.
Aspect 39: The method of any of aspects 29 through 38, wherein transmitting the control signaling comprises: transmitting an indication that the configuration is associated with the second UE.
Aspect 40: The method of any of aspects 29 through 39, wherein transmitting the control signaling comprises: transmitting an indication that the configuration is associated with a first sub-resource pool of a resource pool for sidelink communications, wherein the set of sidelink communication resources comprises the first sub-resource pool, and wherein a guard band separates the first sub-resource pool from a second sub-resource pool of the resource pool.
Aspect 41: The method of any of aspects 29 through 40, wherein transmitting the control signaling comprises: transmitting an indication of a plurality of configurations associated with the set of sidelink communication resources, the plurality of configurations comprising the configuration.
Aspect 42: An apparatus for wireless communications at a first UE, comprising a processor; memory coupled with the processor; and instructions stored in the memory and executable by the processor to cause the apparatus to perform a method of any of aspects 1 through 16.
Aspect 43: An apparatus for wireless communications at a first UE, comprising at least one means for performing a method of any of aspects 1 through 16.
Aspect 44: A non-transitory computer-readable medium storing code for wireless communications at a first UE, the code comprising instructions executable by a processor to perform a method of any of aspects 1 through 16.
Aspect 45: An apparatus for wireless communications at a second UE, comprising a processor; memory coupled with the processor; and instructions stored in the memory and executable by the processor to cause the apparatus to perform a method of any of aspects 17 through 28.
Aspect 46: An apparatus for wireless communications at a second UE, comprising at least one means for performing a method of any of aspects 17 through 28.
Aspect 47: A non-transitory computer-readable medium storing code for wireless communications at a second UE, the code comprising instructions executable by a processor to perform a method of any of aspects 17 through 28.
Aspect 48: An apparatus for wireless communications at a network entity, comprising a processor; memory coupled with the processor; and instructions stored in the memory and executable by the processor to cause the apparatus to perform a method of any of aspects 29 through 41.
Aspect 49: An apparatus for wireless communications at a network entity, comprising at least one means for performing a method of any of aspects 29 through 41.
Aspect 50: A non-transitory computer-readable medium storing code for wireless communications at a network entity, the code comprising instructions executable by a processor to perform a method of any of aspects 29 through 41.

It should be noted that the methods described herein describe possible implementations, and that the operations and the steps may be rearranged or otherwise modified and that other implementations are possible. Further, aspects from two or more of the methods may be combined.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
receiving, from a network entity via a first radio of the first UE, control signaling indicating a configuration associated with a set of sidelink communication resources for receiving signaling via a wake up radio of the first UE while the first radio is in a sleep mode; and
receiving, from a second UE via the wake up radio while the first radio is in the sleep mode, a signal via the set of sidelink communication resources in accordance with the configuration.

2. The method of claim 1, further comprising:
communicating with one of the network entity or the second UE via the first radio based at least in part on receiving the signal via the wake up radio, wherein the signal comprises a wake up signal.

3. The method of claim 2, wherein receiving the control signaling comprises:
receiving an indication of a first subset of the set of sidelink communication resources associated with wake up signals for communications with the network entity and a second subset of the set of sidelink communication resources associated with wake up signals for communications with other UEs, and wherein communicating with the one of the network entity or the second UE is based at least in part on the signal being received via the first subset or the second subset.

4. The method of claim 3, wherein receiving the control signaling comprises:
receiving an indication of one or more of a first discontinuous reception configuration associated with the first subset and a second discontinuous reception configuration associated with the second subset.

5. The method of claim 3, wherein a first discontinuous reception configuration associated with the first subset is associated with a first radio resource control state between the first UE and the network entity, a second discontinuous reception configuration associated with the first subset is associated with a second radio resource control state between the first UE and the network entity, a third discontinuous reception configuration associated with the first subset is associated with a third radio resource control state between the first UE and the network entity, a fourth discontinuous reception configuration associated with the second subset is associated with a fourth radio resource control state between the first UE and the second UE, a fifth discontinuous reception configuration associated with the second subset is associated with a fifth radio resource control state between the first UE and the second UE, and a sixth discontinuous reception configuration associated with the second subset is associated with a sixth radio resource control state between the first UE and the second UE.

6. The method of claim 1, wherein receiving the control signaling comprises:
receiving an indication of the configuration per resource pool, wherein the set of sidelink communication resources comprises a resource pool of a plurality of resource pools associated with a bandwidth part associated with sidelink communications for the first UE.

7. The method of claim 1, further comprising:
transmitting, to the network entity, an indication of a UE type of the first UE, wherein the configuration is based on the UE type.

8. The method of claim 1, further comprising:
receiving, from a third UE via the wake up radio while the first radio is in the sleep mode, a second signal via a default resource pool in accordance with a default configuration.

9. The method of claim 1, further comprising:
transmitting an indication of a quantity of resource pools the UE is capable of supporting via the wake up radio, wherein the configuration is based at least in part on the indication of the quantity of resource pools the UE is capable of supporting via the wake up radio.

10. The method of claim 1, The method of claim 1, wherein receiving the control signaling comprises:
receiving an indication of whether a reference signal, a synchronization signal, or a combination thereof is enabled for a resource pool corresponding to the set of sidelink communication resources.

11. The method of claim 1, wherein receiving the control signaling comprises:
receiving an indication of a plurality of resource pools for sidelink communications, wherein the set of sidelink communication resources comprise a resource pool of the plurality of resource pools, wherein the first UE deactivates monitoring of each resource pool of the plurality of resource pools except for the resource pool while the first radio is in the sleep mode.

12. The method of claim 1, wherein receiving the control signaling comprises:
receiving an indication that the configuration is associated with the second UE.

13. The method of claim 1, wherein receiving the control signaling comprises:
receiving an indication that the configuration is associated with a first sub-resource pool of a resource pool for sidelink communications, wherein the set of sidelink communication resources comprises the first sub-resource pool, and wherein a guard band separates the first sub-resource pool from a second sub-resource pool of the resource pool.

14. The method of claim 1, further comprising:
receiving, with the control signaling, an indication of a plurality of configurations associated with the set of sidelink communication resources, the plurality of configurations comprising the configuration; and
receiving, from the second UE, second control signaling indicating the configuration from the plurality of configurations.

15. A method for wireless communications at a second user equipment (UE), comprising:
receiving, from a network entity, control signaling indicating a configuration associated with a set of sidelink communication resources for transmitting signaling to a first UE while a first radio of the first UE is in a sleep mode; and
transmitting, to the first UE, a signal via the set of sidelink communication resources in accordance with the configuration.

16. The method of claim 15, further comprising:
communicating with the first UE based at least in part on transmitting the signal, wherein the signal comprises a wake up signal.

17. The method of claim 16, wherein receiving the control signaling comprises:
receiving an indication of a first subset of the set of sidelink communication resources associated with wake up signals for communications with the network entity and a second subset of the set of sidelink communication resources associated with wake up signals for communications with other UEs, and wherein communicating with the first UE is based at least in part on the signal being transmitted via the second subset.

18. The method of claim 17, wherein receiving the control signaling comprises:
receiving an indication of one or more of a first discontinuous reception configuration associated with the first subset and a second discontinuous reception configuration associated with the second subset.

19. The method of claim 15, wherein receiving the control signaling comprises:
receiving an indication of the configuration per resource pool, wherein the set of sidelink communication resources comprises a resource pool of a plurality of resource pools associated with a bandwidth part associated with sidelink communications for the first UE.

20. The method of claim 15, wherein receiving the control signaling comprises:
receiving an indication of a plurality of resource pools for sidelink communications, wherein the set of sidelink communication resources comprise a resource pool of the plurality of resource pools.

21. The method of claim 15, wherein receiving the control signaling comprises:
receiving an indication that the configuration is associated with a first sub-resource pool of a resource pool for sidelink communications, wherein the set of sidelink communication resources comprises the first sub-resource pool, and wherein a guard band separates the first sub-resource pool from a second sub-resource pool of the resource pool.

22. The method of claim 15, further comprising:
receiving, with the control signaling, an indication of a plurality of configurations associated with the set of sidelink communication resources, the plurality of configurations comprising the configuration; and
transmitting, to the first UE, second control signaling indicating the configuration from the plurality of configurations.

23. A method for wireless communications at a network entity, comprising:
receiving, from a first user equipment (UE), an indication of a UE type of the first UE; and
transmitting, to the first UE, control signaling indicating a configuration associated with a set of sidelink communication resources for receiving signaling from a second UE while a first radio of the first UE is in a sleep mode.

24. The method of claim 23, further comprising:
transmitting, to the second UE, second control signaling indicating to transmit a wake up signal to the first UE in accordance with the configuration; and
communicating with the first UE based at least in part on transmitting the second control signaling.

25. The method of claim 23, wherein transmitting the control signaling comprises:
transmitting an indication of a first subset of the set of sidelink communication resources associated with wake up signals for communications with the network entity and a second subset of the set of sidelink communication resources associated with wake up signals for communications with other UEs.

26. The method of claim 25, wherein transmitting the control signaling comprises:
transmitting an indication of one or more of a first discontinuous reception configuration associated with the first subset and a second discontinuous reception configuration associated with the second subset.

27. The method of claim 23, wherein transmitting the control signaling comprises:
transmitting an indication of the configuration per resource pool, wherein the set of sidelink communication resources comprises a resource pool of a plurality of resource pools associated with a bandwidth part associated with sidelink communications for the first UE.

28. The method of claim 23, further comprising:
receiving, from the first UE, an indication of a quantity of resource pools the UE is capable of supporting in the sleep mode, wherein the configuration is based at least in part on the indication of the quantity of resource pools the UE is capable of supporting in the sleep mode.

29. The method of claim 23, wherein transmitting the control signaling comprises:
transmitting an indication of whether a reference signal, a synchronization signal, or a combination thereof is enabled for a resource pool corresponding to the set of sidelink communication resources.

30. An apparatus for wireless communications at a first user equipment (UE), comprising:
a processor;
memory coupled with the processor; and
instructions stored in the memory and executable by the processor to cause the apparatus to:
receive, from a network entity via a first radio of the first UE, control signaling indicating a configuration associated with a set of sidelink communication resources for receiving signaling via a wake up radio of the first UE while the first radio is in a sleep mode; and
receive, from a second UE via the wake up radio while the first radio is in the sleep mode, a signal via the set of sidelink communication resources in accordance with the configuration.
